(19) United States
(12) Patent Application Publication
(10) Pub. No.: US 2026/0214519 A1
(43) Pub. Date: Jul. 23, 2026

(54) ENABLING A SELECTIVE ACTIVATION PROCEDURE FOR AN INTRA-DISTRIBUTED-UNIT SCENARIO

(71) Applicant: GOOGLE LLC, Mountain View, CA (US)

(72) Inventors: Ching-Jung Hsieh, Taoyuan City (TW); Chih-Hsiang Wu, Taoyuan City (TW)

(21) Appl. No.: 19/157,317

(22) PCT Filed: Feb. 16, 2024
(86) PCT No.: PCT/US2024/016311

§ 371 Date: Aug. 15, 2025

Related U.S. Application Data
(60) Provisional application No. 63/485,524, filed on Feb. 16, 2023.

(51) Int. Cl. H04W 36/00

(52) U.S. Cl. CPC H04W 36/0069

(57) ABSTRACT

A central unit (CU) of a distributed base station equipped with a first distributed unit (DU) and a second distributed unit (DU) communicates with a user equipment (UE) in dual connectivity (DC), with the first DU operating as a master node (M-DU), and the second DU operating as a secondary node (Se-DU) (502). The CU transmits, to the Se-DU, a CU-to-DU message including a request for reference conditional DU (C-DU) configuration (590); receives, from the Se-DU, a DU-to-CU message including the reference C-DU configuration (590); and generates a conditional SN (C-SN) configuration for the UE based on the reference C-DU configuration (576).

### CROSS-REFERENCE TO RELATED APPLICATION

This application claims priority to and the benefit of the filing date of provisional U.S. Patent Application No. 63/485,524, titled “Enabling a Selective Activation Procedure for an Intra-Distributed-Unit Scenario,” filed on Feb. 16, 2023. The entire contents of the provisional application are hereby expressly incorporated herein by reference.

### FIELD OF THE DISCLOSURE

This disclosure relates generally to wireless communications and, more particularly, to managing conditional configurations to enable continuous conditional cell changes.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) sometimes can concurrently utilize resources of multiple radio access network (RAN) nodes, such as base stations or components of a distributed base station, interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE transfers a wireless connection from one base station to another base station. For example, a serving base station can determine to hand the UE over to a target base station and initiate a handover procedure.

3GPP specification TS 37.340 v16.6.0 describes procedures according to which a UE can add or change an SN in DC scenarios. These procedures involve messaging (e.g., RRC signaling and preparation) between radio access network (RAN) nodes. This messaging generally causes latency, which in turn increases the probability that the SN addition or SN change procedure will fail. These legacy procedures, which do not involve conditions that are checked at the UE, can be referred to as “immediate” SN addition and SN change procedures.

More recently, for both SN or PSCell addition/change, “conditional” procedures have been considered (i.e., conditional SN or PSCell addition/change). Unlike the “immediate” procedures discussed above, these procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

In the immediate PSCell addition or change procedure, the RAN (i.e., MN or SN) transmits an RRC reconfiguration message including multiple configuration parameters to the UE and the UE attempts to connect to a (target) PSCell configured by the RRC reconfiguration message. After the UE successfully connects to the SN via the PSCell, the UE communicates with the SN on the PSCell by using the multiple configuration parameters and security key(s) associated to the PSCell and derived from one or more security configuration parameters in the RRC reconfiguration message. The SN also derives security key(s) that match the security key(s) derived from the UE. After the UE successfully connects to the PSCell, the RAN (e.g., the SN) communicates data with the UE by using the matching security key(s) and the multiple configuration parameters.

In some cases, a candidate SN (C-SN) (or target SN (T-SN), which can be inter-changed with each other throughout this document) provides multiple candidate configurations when, for example, multiple candidate PSCells are available. When the MN completes the preparation for a conditional SN procedure (e.g., conditional SN addition or conditional SN cell change), the MN at this time cannot determine which candidate secondary cell the UE will connect to in the future. Moreover, because the UE connects to the secondary cell only subject to the fulfillment of one or more conditions, the MN cannot determine whether the UE will even connect to any of the candidate cells in the future.

In 3GPP Release 17 Conditional PSCell change (CPC)/Conditional PSCell addition or change (CPAC), the RAN (e.g., the MN or SN) can transmit multiple candidate configurations to the UE. However, when the UE determines that a triggering condition is fulfilled for a specific one of the candidate configurations, the UE executes the specific candidate configuration and performs random access towards a candidate PSCell configured in the specific candidate configuration. The UE releases the configurations after completing random access towards the candidate PSCell.

Because the UE releases all of the candidate configurations, the UE does not have a chance to perform subsequent CPAC without receiving new candidate configuration(s) from the network. Recently, 3GPP proposed supporting continuous CPAC (i.e., subsequent CPAC after a CPAC) without new CPAC preparation from the network. “Continuous CPAC” is also referred to as a MR-DC with selective activation of cell groups aiming at reducing signaling overhead between MN and C-SNs and between MN and UE and interrupting time for SCG change.

However, it is not clear how the MN and the C-SNs should manage configurations to ensure that the RAN and the UE use the same candidate configuration to communicate with each other when the triggering condition is fulfilled during the continuous CPAC operations. It is also not clear how the network should use a reference distributed unit (DU) to prepare selective activation configuration(s) at the DU and the central unit (CU) of the base station. As a more specific example, it is not clear how a base station should manage such configurations in an intra-DU CPC scenario when the UE operates in intra-base station DC (i.e., a base station serves as the MN and the SN simultaneously). The CU and the DU also require solutions to differentiate the reference DU configuration, the conditional DU configuration, and the immediate DU configuration for the UE to apply correspondently.

### SUMMARY

An example embodiment of the techniques of this disclosure is a configuration method implemented in a central unit (CU) of a distributed base station equipped with a first distributed unit (DU) and a second distributed unit (DU). The method comprises communicating with a user equipment (UE) in dual connectivity (DC), with the first DU operating as a master node (M-DU), and the second DU operating as a secondary node (Se-DU); transmitting, to the Se-DU, a CU-to-DU message including a request for reference conditional DU (C-DU) configuration; receiving, from the Se-DU, a DU-to-CU message including the reference C-DU configuration; and generating a conditional SN (C-SN) configuration for the UE based on the reference C-DU configuration.

Another example embodiment of these techniques is a method implemented in a distributed unit (DU) of a distributed base station. The method comprises providing, with a master node (MN), dual connectivity to a user equipment (UE); receiving an indication to perform a preparation procedure for subsequent conditional primary-secondary cell (PSCell) addition or change (CPAC) at the UE; transmitting, to a central unit (CU) of the distributed base station and responsive to the receiving the indication, a reference conditional DU (C-DU) configuration; and receiving, from the CU, a conditional SN (C-SN) configuration for the UE.

Another example embodiment of these techniques is a radio access network (RAN) node comprising processing hardware and configured to perform one of the methods above.

### BRIEF DESCRIPTION OF THE DRAWINGS

FIG. 1A is a block diagram of an example system in which a base station and/or a user equipment (UE) can implement the techniques of this disclosure for managing conditional procedures related to a master node (MN) or a secondary node (SN);

FIG. 1B is another block diagram of an example system in which a radio access network (RAN) and a user device can implement the techniques of this disclosure for managing conditional procedures related to an MN or an SN;

FIG. 1C is a block diagram of an example base station including a central unit (CU) and a distributed unit (DU) that can operate in the system of FIG. 1A or FIG. 1B;

FIG. 2 is a block diagram of an example protocol stack according to which the UE of FIGS. 1A-1B can communicate with base stations;

FIG. 3A is a messaging diagram of an example scenario where an MN receives and processes one or more SN configurations from a C-SN during a Conditional SN Addition procedure for continuous CPAC;

FIG. 3B is a messaging diagram of an example scenario where an MN receives and processes one or more SN configurations from a C-SN during an MN-initiated Conditional SN Change procedure for continuous CPAC;

FIG. 3C is a messaging diagram of an example scenario where an MN receives and processes one or more SN configurations from a C-SN during an SN-initiated Conditional SN Change scenario for continuous CPAC;

FIG. 4A is a messaging diagram of an example scenario where the SN initiates an intra-SN continuous CPAC via the MN;

FIG. 4B is a messaging diagram of an example scenario where the SN initiates an intra-SN continuous CPAC without MN involvement;

FIG. 5A is a messaging diagram of an example scenario where the base station initiates an intra-DU continuous CPC via the Master DU;

FIG. 5B is a messaging diagram of an example scenario where the base station initiates an intra-DU continuous CPC via the Secondary DU;

FIGS. 6-8 are flow diagrams of example methods where a DU of a base station performs an intra-DU continuous CPC preparation with a CU of the base station;

FIG. 9 is a flow diagram of example methods where a CU of a base station performs an intra-DU continuous CPC with a DU of the base station;

FIGS. 10A-10C are flow diagrams of example methods where a DU of a base station determines to transmit a DU configuration for a UE using a specific field/IE depending on the type of the DU configuration; and

FIGS. 11A-11D are flow diagrams of example methods where a DU of a base station determines to transmit one or more DU configuration(s) for a UE using specific field(s)/IE(s) depending on the type of the DU configuration.

### DETAILED DESCRIPTION OF THE DRAWINGS

As discussed in detail below, a UE and/or one or more base stations manage conditional procedures, such as conditional PSCell addition or change (CPAC). This disclosure may also refer to a conditional PSCell addition procedure and a conditional PSCell change procedure separately using the acronyms CPA and CPC, respectively.

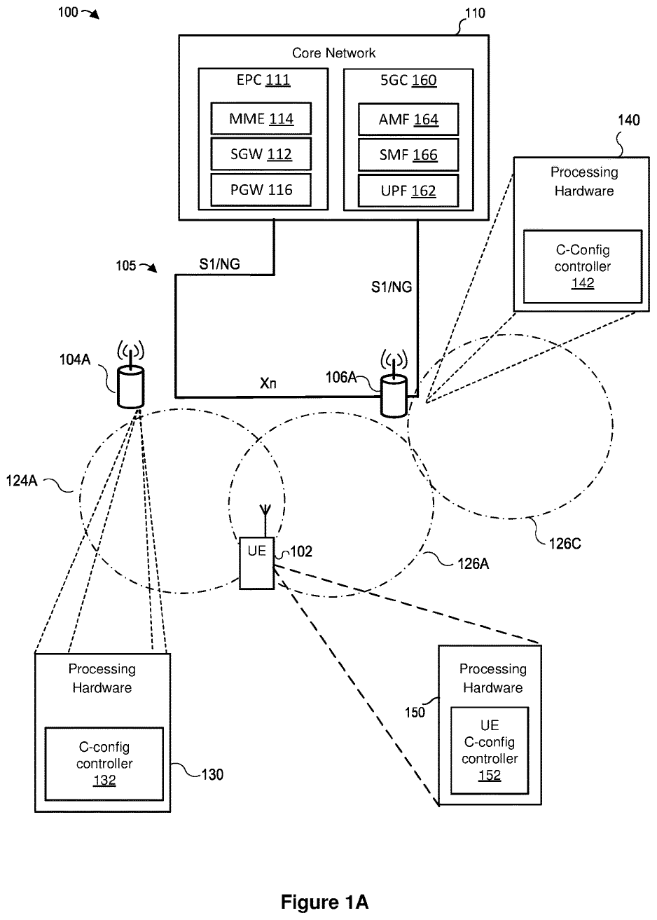

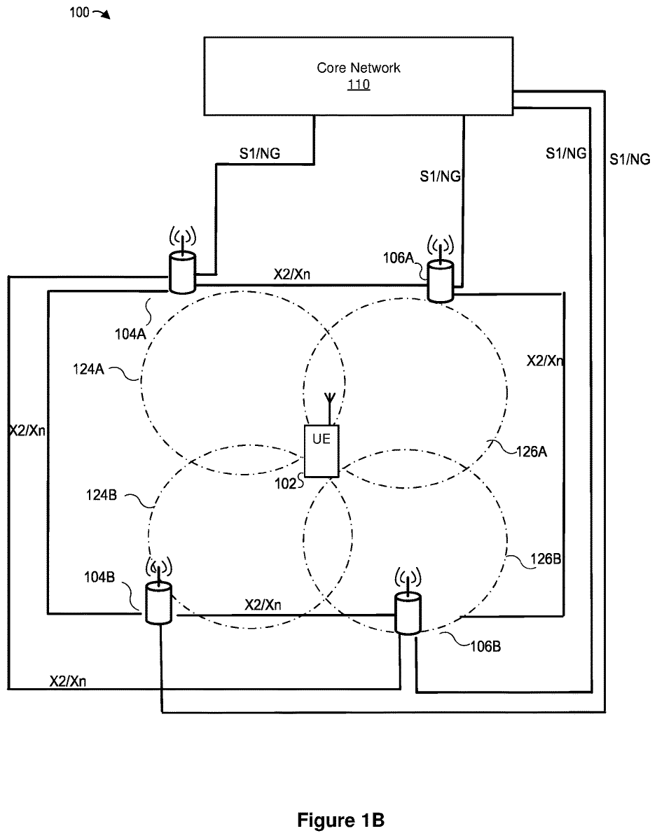

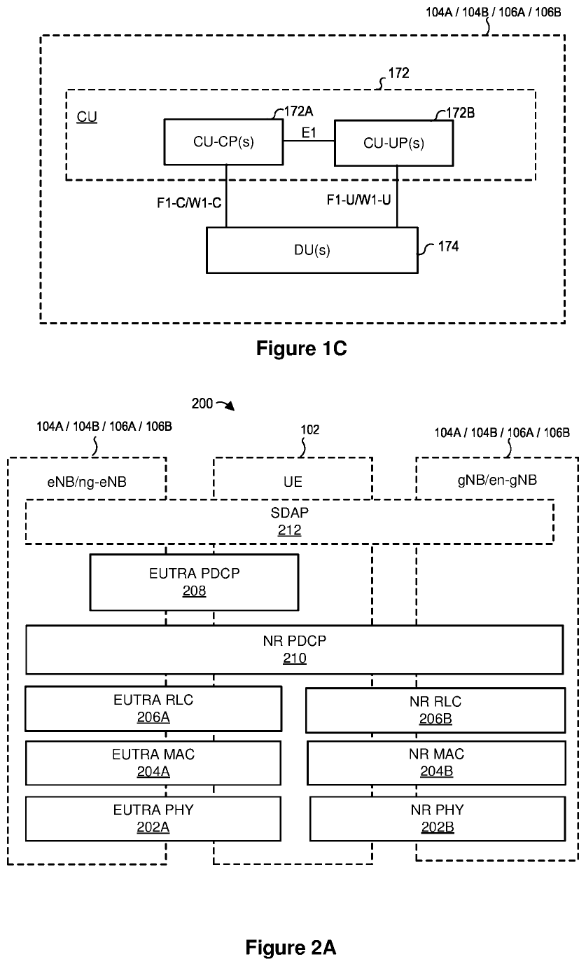

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts additional base stations 104B and 106B, which may be included in the wireless communication system 100. The UE 102 initially connects to the base station 104A. The BSs 104B and 106B may have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1. Extending multi-connectivity coordination can help the newly-added base station coordinate shared UE capabilities.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A may determine to perform the conditional SN Addition procedure in response to a request received from the base station 106A or in response to one or more measurement results received from the UE 102 (e.g., extracted from a UE measurement report) or obtained by the MN 104A from measurements on signals (e.g., sounding reference signal (SRS) or uplink demodulation reference signal (DMRS)) received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). Before the condition is satisfied, multi-connectivity coordination is not necessary; however, it will be helpful as soon as a C-SN becomes connected. When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured with a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results, which may be received from the UE 102 via the SRB or via the MN 104A or may be obtained by the SN 106A from measurements on signals received from the UE 102. In case of via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A may configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A optionally may configure the base station 106B as another C-SgNB to the UE 102. In some cases, an MeNB, an SeNB or a C-SgNB is implemented as an ng-eNB rather than an eNB. When the base station 104A is a Master ng-eNB (Mng-eNB) and the base station 106A is a SgNB, the UE 102 can be in next generation (NG) EUTRA-NR DC (NGEN-DC) with the Mng-eNB and the SgNB. In this scenario, the MeNB 104A optionally may configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A optionally may configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MeNB 104A optionally may configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A optionally may configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A optionally may configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A optionally may configure the base station 106B as another C-Sng-eNB to the UE 102.

The base stations 104A, 106A, and 106B can connect to the same core network (CN) 110, which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-eNB, or an MgNB, and the base station 106A operates as an SgNB or an Sng-eNB. The cells 124A and 126B can partially overlap. When the UE 102 is in SC with the base station 104A, the base station 104A operates as an MeNB, an Mng-eNB or an MgNB, and the base station 106B operates as a C-SgNB or a C-Sng-eNB.

When the UE 102 operates in DC with the base station 104A and the base station 106A, the base station 104A operates as an MeNB, an Mng-eNB or an MgNB, the base station 106A operates as an SgNB or an Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR- 6G DC.

FIG. 1C depicts an example distributed implementation of a base station such as the base station 104A, 104B, 106A, or 106B. The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as an MN, an SN or a candidate SN (C-SN). The processing hardware may include further a physical layer controller configured to manage or control one or more physical layer operations or procedures.

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

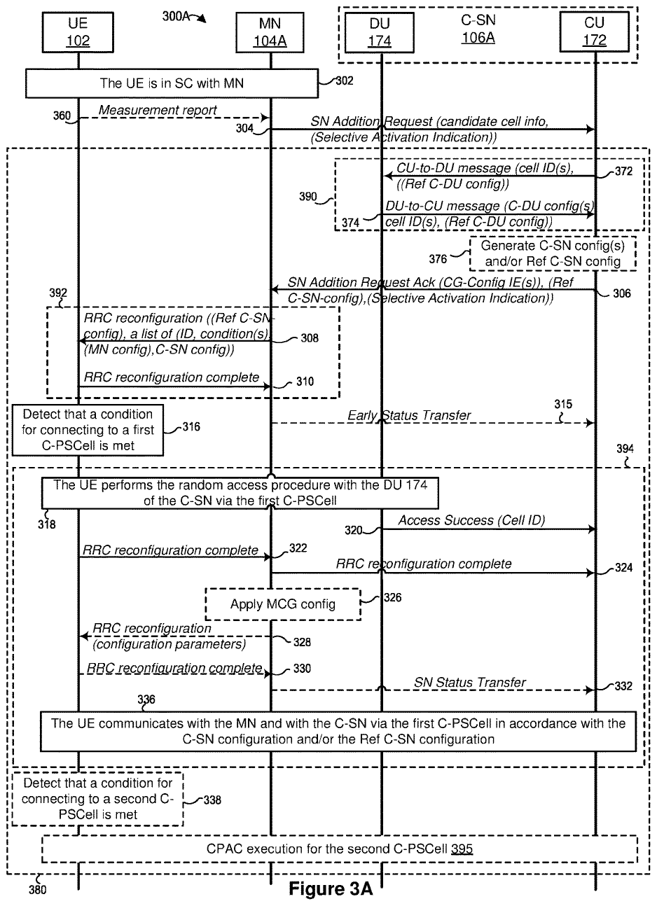

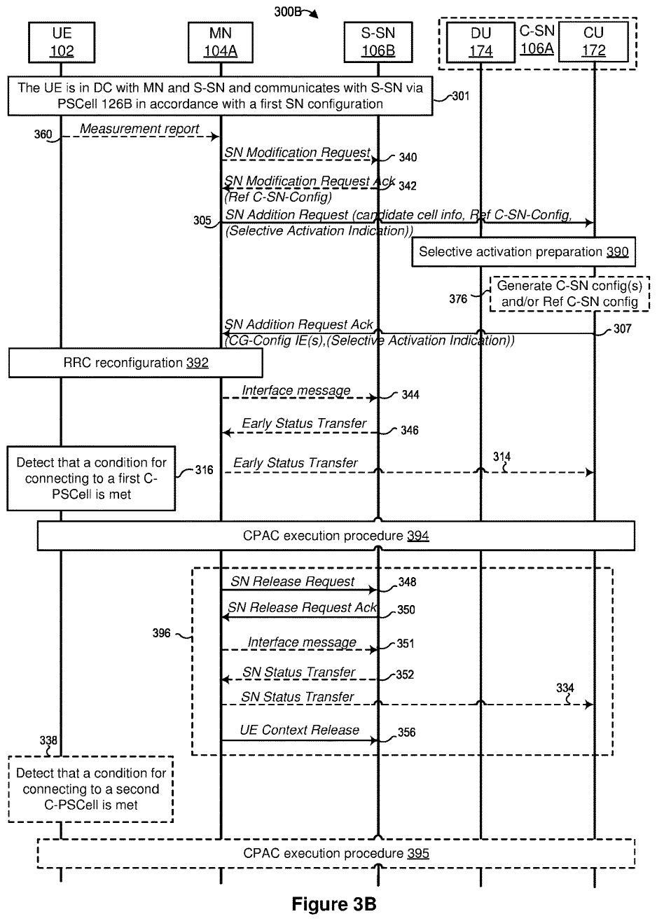

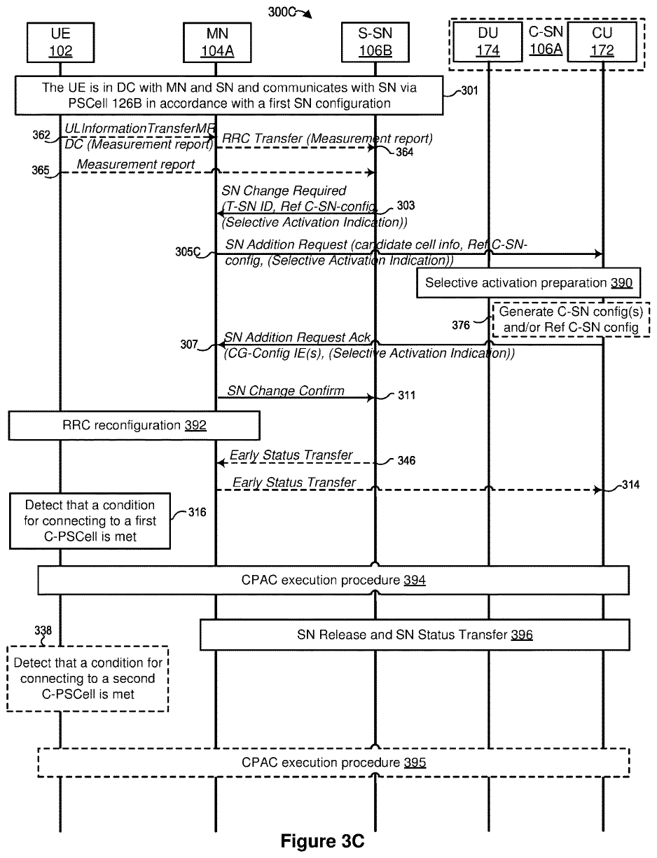

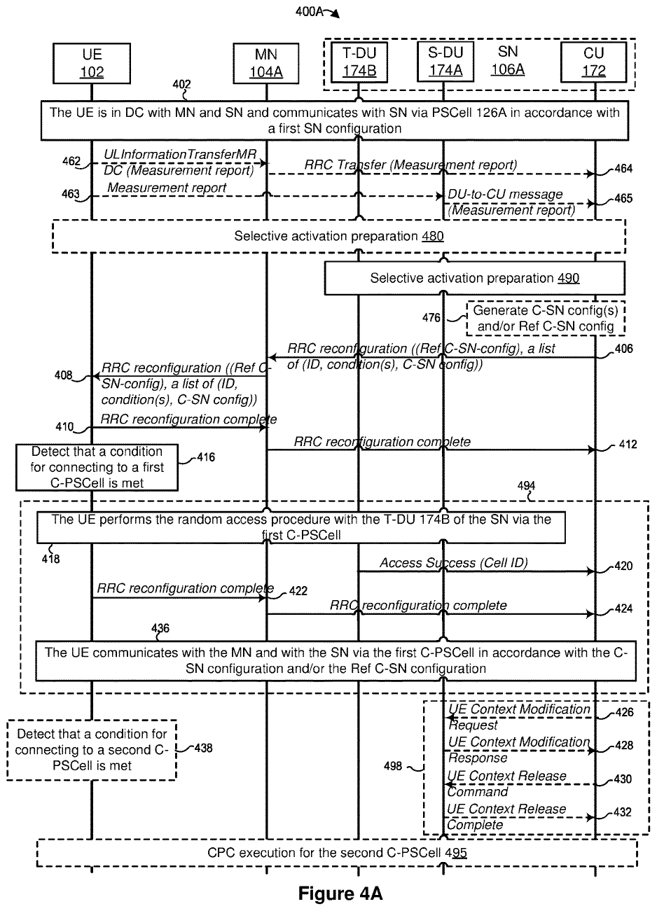

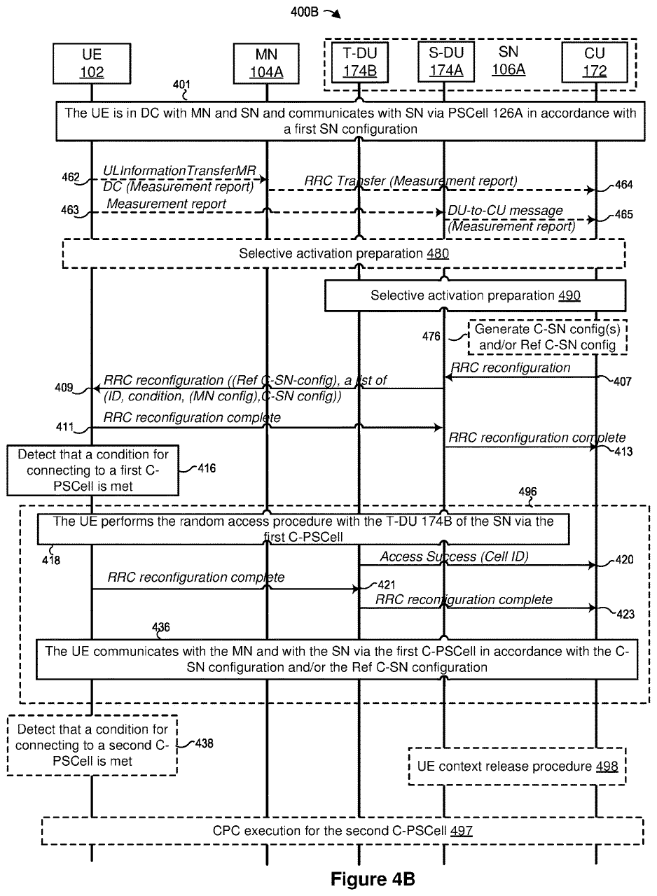

Next, several example scenarios in which a UE and/or a RAN perform the techniques of this disclosure for supporting conditional procedures are discussed with reference to FIGS. 3A-3C and 4A-B. Generally speaking, similar events in FIGS. 3A-3C and 4A-B are labeled with the same reference numbers, with differences discussed below where appropriate.

Referring first to FIG. 3A, in a scenario 300A, an MN receives and processes one or more C-SN configurations from a C-SN during a conditional SN addition procedure. In the scenario 300A, the base station 104A in a scenario 300A operates as an MN, and the base station 106A operates as a C-SN. The base station 106A includes a CU 172 and a DU 174 and the DU 174 operates the cell 126A and other cells. Initially, the UE 102 operates 302 in single connectivity (SC) with the MN 104A. While in SC, the UE 102 communicates UL PDUs and/or DL PDUs with the MN 104A (e.g., via a PCell 124A) in accordance with an MN configuration.

At a later time, the MN 104A determines to configure the base station 106A as a C-SN for conditional PSCell addition (CPA) for the UE 102. The MN 104A can make this determination based on measurement result(s) from the UE 102, for example. In some implementations, the UE 102 performs measurements and transmits the measurement result(s) in accordance with a measurement configuration configured by the MN 104A. In some implementations, the MN 104A can detect or estimate that the UE 102 is moving toward coverage (i.e., one or more cells) of the base station 106A based on uplink signals received from the UE 102 or positioning measurement result(s) received from the UE 102. In response to the determination, the MN 104A sends 304 a SN Addition Request message including a first indication (e.g., Selective Activation Indication IE) for continuous CPAC to the CU 172 of the C-SN 106A. In the description of this invention, “continuous CPAC” is also referred to as a MR-DC with selective activation of cell groups or a “selective activation preparation”. A cell group comprises of one MAC entity, a set of logical channels with associated RLC entities and of a primary cell (SpCell) and one or more secondary cells (SCells). In some implementations, the MN 104A includes Conditional PSCell Addition (CPA) information (e.g., Conditional PSCell Addition Information Request IE) in the SN Addition Request message. In one implementation, the Conditional PSCell Addition Information Request IE includes a Maximum Number of PSCells To Prepare IE/field. In some implementation, the MN 104A includes the first indication in the Conditional PSCell Addition Information Request IE. In other implementations, the MN 104A includes the first indication and Conditional PSCell Addition Information Request IE as different IEs (e.g., XnAP or X2AP IEs) of the SN Addition Request message.

In some implementations, the MN 104A generates a candidate cell information (e.g., CandidateCellInfoListMN) including the measurement result(s) of the one or more cells and include the candidate cell information in the SN Addition Request message. In some implementations, the MN 104A determines SN restriction information to restrict (values of) configuration parameters that the C-SN 106A can configure for the UE 102, and includes the SN restriction information in the SN Addition Request message. In some implementations, the MN 104A includes the candidate cell information and/or the SN restriction information in an inter-node RRC message (i.e., CG-ConfigInfo IE) and include the inter-node RRC message in the SN Addition Request message. Alternatively, the MN 104A includes the SN restriction information outside of the CG-ConfigInfo in the SN Addition Request message. The MN 104A may determine MN restriction information to restrict (values of) configuration parameters that the MN 104A can configure for the UE 102 when determining the SN restriction information. In some implementations, the MN 104A includes CPA information in the SN Addition Request message. For example, the CPA information (e.g., Conditional PSCell Addition Information Request IE) includes an IE indicating the maximum number of PSCells that the C-SN 106A may prepare.

In some implementations, the MN 104A includes a first reference C-SN configuration in the SN Addition Request message for the purpose of continuous CPAC. The MN 104A can obtain the first reference C-SN configuration (e.g., C-SN configuration 0) from a C-SN (e.g., C-SN 0). Alternatively, the MN 104A can be pre-configured with the first reference C-SN configuration. As yet another alternative, the MN 104A generates the first reference C-SN configuration. In some implementations, the MN 104A includes the first reference C-SN configuration in the sourceConfigSCG field/IE in the CG-ConfigInfo IE and include the CG-ConfigInfo IE in the SN Addition Request message. In other implementations, the MN 104A includes the first reference C-SN configuration in a dedicated (specifically defined for the purposes of this procedure) field/IE (e.g., Ref C-SN Config) in the CG-ConfigInfo IE and include the CG-ConfigInfo IE in the SN Addition Request message. In other implementations, the MN 104A refrains from including a first reference C-SN configuration in the SN Addition Request message, when MN 104A decides to perform CPA to the C-SN 106A and there is no available first reference C-SN configuration. In some implementations, the CU 172 of the C-SN 106A decodes the first reference C-SN configuration received from the MN 104A (e.g., in event 304) and extracts or generates the first reference C-DU configuration based on the first reference C-SN configuration. The reference C-DU configuration configures the lower layer parameters including physical layer configuration parameters, MAC configuration parameters, and/or RLC configuration parameters of a cell group. In some implementations, the reference C-DU configuration is CellGroupConfig IE defined in 3GPP specification 38.331. In other implementations, the reference C-DU configuration includes configuration parameters in the CellGroupConfig IE. The reference C-SN configuration, in addition to the reference C-DU configuration, further consists of a reference CU configuration. In some implementations, the reference CU configuration includes PDCP configuration parameters, measurement configuration parameters, and/or radio bearer configuration parameters. In some implementations, the reference CU configuration includes a MeasConfig IE and/or a RadioBearerConfig IE defined in 3GPP specification 38.331 or includes configuration parameters in the MeasConfig IE and/or RadioBearerConfig IE. In other implementations, the CU 172 of the C-SN 106A does not have the first reference C-SN configuration and therefore does not generate the first reference C-DU configuration. In some implementations, the CU 172 of the C-SN 106A does not decode and re-encode the reference C-DU configuration from the reference C-SN configuration and provides the C-DU configuration in the C-SN configuration to the DU 174 directly.

In response to receiving 304 the SN Addition Request message with CPAC indication and/or the first indication and/or the reference C-SN configuration, the CU 172 of the C-SN 106A determines M₁ C-PSCell(s) (where M₁ is a positive integer) operated by the DU 174.

In one implementation, the CU 172 sends 372 a first CU-to-DU message including the cell identity (ID) for the first C-PSCell and/or the first reference C-DU configuration to the DU 174 for the UE 102. For example, the cell ID is cell global identity (CGI). In some implementations, the first reference C-DU configuration is contained in the reference C-SN configuration or in the RRC container (e.g., CG-ConfigInfo IE) that the CU 172 received from the MN 104A. In other implementations, the first reference C-DU configuration is solely included as a separate F1AP IE in the first CU-to-DU message. The DU 174 in response sends 374 a first DU-to-CU message including the first C-DU configuration for the first C-PSCell. The DU 174 can include the cell ID for the first C-PSCell, and/or a second reference C-DU configuration in the DU-to-CU message. The CU 172 and the DU 174 identify the C-DU configuration by the cell ID for the UE 102. Then events 372 and 374 can be collectively referred to as a selective activation preparation procedure 390. The CU 172 and the DU 174 can perform 390 the selective activation preparation procedure(s) sequentially or in parallel with the first C-PSCell for the rest of (M₁−1) C-PSCell(s) in response to the determination. The CU 172 therefore obtains from the DU 174 the M₁ C-DU configuration(s) where each C-DU configuration is associated with a particular C-PSCell of the M₁ C-PSCell(s) (i.e., C-PSCell(s) 1, . . . , M₁).

In another implementation, the CU 172 sends 372 a CU-to-DU message including the cell ID(s) for the M₁ C-PSCell(s) and/or the first reference C-DU configuration to the DU 174. The DU 174 in response sends 374 a DU-to-CU message including the M₁ C-DU configuration(s) for the first C-PSCell. The DU 174 can include the cell ID(s) for the M₁ C-PSCell(s), and/or a second reference C-DU configuration in the DU-to-CU message. In such implementation, the CU 172 obtains from the DU 174 the M₁ C-DU configuration(s) using one single selective activation preparation procedure 390.

In some implementations, the CU-to-DU message at the event 372 is a UE Context Setup Request or a UE Context Modification Request message and the DU-to-CU message at the event 374 is a UE Context Setup Response or a UE Context Modification Response message. In some implementations, the DU 174 generates the C-DU configuration(s) based on the first reference C-DU configuration if the DU 174 receives it in the CU-to-DU message. In such cases, the DU 174 generates the C-DU configuration(s) 1, and/or 2, . . . , M₁ which are delta configuration(s) to augment the first reference C-DU configuration. In other implementations, the DU 174 does not receive the first reference C-DU configuration from the CU 172 (e.g., the sourceConfigSCG field/IE or the Ref C-SN Config field/IE is absent from in the CG-ConfigInfo IE) and generates the second reference C-DU configuration from scratch. The DU 174 in such implementations generates the C-DU configuration(s) based on the second reference C-DU configuration. In such cases, the DU 174 generates the C-DU configuration(s) 1, and/or 2, . . . , M₁ which are delta configuration(s) to augment the second reference C-DU configuration. In some implementations, the CU 172 includes in the first CU-to-DU message an indication of selective activation or a query for the reference C-DU configuration and the DU 174 generates the second reference C-DU configuration in response to the indication or query.

The CU 172, based on the received C-DU configuration(s) 1, . . . , M₁, generates 376 the C-SN configuration(s) 1, . . . , M₁ for the UE 102, where each C-SN configuration is associated with a particular C-PSCell of the M₁ C-PSCell(s) (i.e., C-PSCell(s) 1, . . . , M₁), respectively. For example, the C-PSCell(s) includes the cell 126A and/or the cell 126C. The CU 172 can also generate 376 a second reference C-SN configuration based on the second reference C-DU configuration. In some implementations, the CU 172 generates the CU configuration including PDCP configuration parameters, measurement configuration parameters, and/or radio bearer configuration parameters. The CU 172 generates the C-SN configuration(s) by combining the C-DU configuration(s) and the CU configuration(s). The CU 172 can generate the second reference C-SN configuration similarly. The CU 172 generates an inter-node message (e.g., CG-CandidateList) to include the C-SN configuration(s) 1, . . . , M₁ for the UE 102. In some implementations, M₁ is not larger than the maximum number of PSCells which can be received in the SN Addition Request message or determined by the C-SN 106A. In some implementations, the CU 172 of the C-SN 106A determines the C-PSCell(s) and the C-SN configuration(s) 1, . . . , M₁ taking into account the candidate cell information and the SN restriction information. The inter-node message includes an addition list (e.g., cg-CandidateToAddModList) of CG-CandidateInfo IE(s), where each corresponds to a C-PSCell. Each CG-CandidateInfo IE in the addition list includes a CG-CandidateInfo ID (e.g., cg-CandidateInfold or CG-CandidateInfoId that includes C-PSCell information for a C-PSCell (e.g., SSB frequency information (e.g., ARFCN-ValueNR)) and the physical Cell ID (PCI)) and a CG-Config IE. Each CG-Config IE includes a C-SN configuration for a corresponding C-PSCell and optionally parameters for the MN 104A to prepare a corresponding MN configuration to coordinate with the C-SN configuration, if necessary. The CG-CandidateInfo ID(s) can be used by the C-SN 106A and the MN 104A for management of CG-CandidateInfo IE(s) in the addition list. In some implementations, the MN 104A uses the first indication to indicate to the C-SN 106A that, different from conventional or 3GPP Release 17 CPAC procedure, the prepared C-SN configuration(s) will not be released by the UE 102 when UE 102 accesses one of the C-SN configuration(s) from the C-SN 106A or other C-SN(s).

The CU 172 of the C-SN 106A transmits 306 an SN Addition Request Acknowledge message including the CG-CandidateList and/or a Conditional PSCell Addition Information Acknowledge IE including the list of accepted candidate cell (CGI) to the MN 104A in response to the SN Addition Request message. The CU 172 of the C-SN 106A includes the M₁ C-SN configuration(s) in the CG-CandidateList. In some implementations, the CU 172 of the C-SN 106A includes a reference C-SN configuration (e.g., Ref C-SN-config) in the SN Addition Request Acknowledge message for the MN 104A to prepare CPAC with other C-SN(s) for the UE 102 as described below. In some implementations, the CU 172 of the C-SN 106A includes the reference C-SN configuration and the CG-CandidateList in separate IEs (e.g., XnAP or X2AP IEs) of the SN Addition Request Acknowledge message. In other implementations, the CU 172 of the C-SN 106A includes the reference C-SN configuration in the CG-CandidateList IE. In some implementations, the MN 104A includes an indication to request a reference C-SN configuration. The CU 172 of the C-SN 106A includes the reference C-SN configuration in the SN Addition Request Acknowledge message in response to the indication. The indication can be an IE such as query IE (e.g., Reference C-SN Configuration Query), a reference configuration request IE or reference configuration indication IE. In some implementations, each of the M₁ C-SN configuration(s) is a delta configuration augmenting the reference C-SN configuration. In other words, the M₁ C-SN configuration(s) is associated with the reference C-SN configuration. In other implementations, the CU 172 of the C-SN 106A refrains from including a reference C-SN configuration in the SN Addition Request Acknowledge message. In some implementations, the reference C-SN configuration included in the SN Addition Request Acknowledge message is the second reference C-SN configuration that the CU 172 of the C-SN 106A generates based on the second reference C-DU configuration it received from the DU 174 as described above. In other implementations, the reference C-SN configuration included in the SN Addition Request Acknowledge message is the first reference C-SN configuration that the CU 172 of the C-SN 106A receives in the SN Addition Request message.

After receiving 306 the SN Addition Request Acknowledge message including the CG-CandidateList, the MN 104A can assign a particular configuration ID (e.g., condReconfigId or CondReconfigurationId) to each of the C-SN configuration(s) in the CG-Config IE(s). For example, in cases where the CG-Config IE(s) 1, . . . , M₁ include the C-SN configuration(s) 1, . . . , M₁, the MN 104A can assign configuration ID(s) 1, . . . , M₁ for the C-SN configuration(s) 1, . . . , M₁, respectively. The MN 104A can generate the triggering condition configuration(s) (e.g., condExecutionCond field(s)/IE(s) for the C-SN configuration(s) 1,. M₁, respectively. Each of the triggering condition configuration(s) can configure one or more conditions that triggers the UE 102 to connect to the C-SN 106A via a particular C-PSCell configured in a particular C-SN configuration. The MN 104A can generate corresponding MN configuration(s) 1, . . . , M₁, based on the parameters received in the CG-Config IE(s) 1, . . . , M₁, to coordinate with the C-SN configuration(s) 1, . . . , M₁, respectively. In some implementations, the MN 104A can generate MN message(s) or RRC container message(s) (e.g., RRCConnectionReconfiguration messages or RRCReconfiguration messages) 1, . . . , M, including the C-SN configuration(s) and/or the corresponding MN configuration(s) 1, . . . , M₁, respectively. The MN 104A generates condRRCReconfig field(s)/IE(s) 1, . . . , M₁ to include the MN message(s) or RRC container message(s) 1, . . . , M), respectively. The MN 104A generates conditional (re)configuration field(s)/IE(s) (e.g., CondReconfigToAddMod field(s)/IE(s) 1, . . . , M₁ including the condRRCReconfig field/IE 1, . . . , M₁, the configuration ID(s) (e.g., condReconfigId) 1, . . . , M₁, and the triggering condition configurations (e.g., condExecutionCond) 1, . . . , M₁, respectively. The MN 104A transmits 308 a RRC reconfiguration message including the conditional (re)configuration fields/IEs 1, . . . , M₁ to the UE 102. For example, the RRC reconfiguration message is a RRCConnectionReconfiguration message or RRCReconfiguration message. In some implementations, the MN 104A may generate a first list (e.g., CondReconfigToAddModList) of the conditional (re)configuration field/IEs (e.g., CondReconfigToAddMod). The MN 104A transmits 308 the RRC reconfiguration message including the first list to the UE 102.

In some implementations, the MN 104A includes the reference C-SN configuration in the RRC reconfiguration message in the event 308. In other implementations, the MN 104A includes the reference C-SN configuration in a separate RRC reconfiguration message other than the RRC reconfiguration message of the event 308 and transmits the separate RRC reconfiguration message to the UE 102. In some implementations, the MN 104A includes the reference C-SN configuration in the first list. In other implementations, the MN 104A does not include the reference C-SN configuration in the first list but in a separate field/IE in the RRC reconfiguration message of the event 308. In response, the UE 102 transmits 310 an RRC reconfiguration complete message (e.g., RRCConnectionReconfigurationComplete message or RRCReconfigurationComplete message) to the MN 104A. The events 308 and 310 collectively define an RRC reconfiguration procedure 392.

In some implementations, based on the determination to perform continuous CPAC, the MN 104A determines to configure additional N−1 C-SNs for the UE 102, N is a positive integer larger than 1. In such cases, the C-SN 106A is the first C-SN (i.e., C-SN 1) among the total N C-SNs. The interactions between the MN 104A and the C-SN 2, . . . , N, are similar to the interactions between the MN 104A and the C-SN 1 as described above for the events 304, 306, 372, 374, 376, 308 and 310. If the C-SN 1 (i.e., C-SN 106A) includes a reference C-SN configuration in the SN Addition Request Acknowledge message 306 for the MN 104A as describe above, the MN 104A may include the reference C-SN configuration in SN Addition Request messages that the MN 104A transmits to the C-SN(s) 2, . . . , N, respectively. Each of the C-SN(s) 2, . . . , N, therefore generates C-SN configuration(s) based on the reference C-SN configuration. In some implementations, each of the C-SN configuration(s) is a delta configuration augmenting the reference C-SN configuration. In case that the C-SN 2, . . . , N also consists of CU and DU(s), the interactions between the CU and the DU(s) are similar to the interactions between the CU 172 and the DU 174 of the C-SN 106A as described above in the events 372, 374 and 376.

In some implementations, for each of the N−1 C-SN(s), the MN 104A performs an RRC reconfiguration procedure with the UE 102 similar to the event 392. In other implementations, the MN 104A includes the C-SN configuration(s) received from the N−1 C-SN(s) in the RRC reconfiguration message of the event 308 similar to including the C-SN configuration(s) 1, . . . , M as described above. In some implementations, the MN 104A can manage the C-SN configurations from the WC-SNs for the UE 102 as below. Assumes that there are M₁ C-SN configurations from the C-SN 1, M₂ C-SN configurations from the C-SN 2, . . . , and MN C-SN configurations from the C-SN N, where Mᵢ is a positive integer and i is a number between 1 to N. The MN 104A, for example, can assign configuration ID 1, .. . . , M₁ to the M₁ C-SN configurations from the C-SN 1 (and the corresponding MN configurations), configuration ID (M₁+1), . . . , (M₁+M₂) to the M₂ C-SN configurations from the C-SN2 (and the corresponding MN configurations), . . . , and configuration ID (M₁+M₂+ . . . +M_{N-1}+1), . . . , (M₁+M₂+ . . . +M_{N}) to the M_{N} C-SN configurations from the C-SN N (and the corresponding MN configurations). The MN 104A transmits the (M₁+M₂+ . . . +M_{N}) C-SN configurations (and the corresponding MN configurations) in one or more conditional configuration lists (e.g., CondReconfigToAddModList) to the UE 102. For example, the MN 104A transmits the C-SN configurations with configuration ID 1, . . . , M₁, in a first CondReconfigToAddModList and transmits the C-SN configurations with configuration ID (M₁+1), . . . (M₁+M₂+ . . . +M_{N}) in a second CondReconfigToAddModList to the UE 102.

After receiving 310 the RRC reconfiguration complete message or an acknowledgement (e.g., RLC acknowledgement or hybrid automatic repeat request (HARQ) acknowledgement) for a PDU (e.g., RLC PDU or MAC PDU) including the RRC reconfiguration message 308, the MN 104A can (determine to) send 315 an Early Status Transfer message to the C-SN 106A and/or C-SN(s) 2, . . . , N to transfer a COUNT value of the first downlink SDU that the MN 104A forwards to the C-SN 106A and/or C-SN(s) 2, . . . , N or a COUNT value for discarding of already forwarded downlink SDUs for each of DRB(s) of the UE 102. The Early Status Transfer message may be an Early Sequence Number (SN) Status Transfer message, where “SN” in this context refers to sequence number rather than secondary node. The MN 104A can send 315 the Early Status Transfer message without receiving an interface message indicating the UE 102 connects to the C-SN 106A and/or N−1 C-SN(s).

The UE 102 may use the one or more conditions to determine whether to connect to the one of the C-PSCell(s). If the UE 102 detects 316 that a condition for connecting to a first C-PSCell (e.g., the C-PSCell 1 of the C-SN 106A) is satisfied, the UE 102 connects to the first C-PSCell. That is, the condition (i.e., “triggering condition”) triggers the UE 102 to connect to the first C-PSCell or to execute the C-SN configuration concerning the first C-PSCell. However, if the UE 102 does not detect that the condition is satisfied, the UE 102 does not connect to the first C-PSCell. In response to the detection, the UE 102 initiates a random access procedure on the first C-PSCell. In response to the initiation, the UE 102 performs 318 the random access procedure with the DU 174 of the C-SN 106A via the first C-PSCell (e.g., the cell 126A). The UE 102 performs the random access procedure in accordance with the random access configurations of the C-DU configuration and/or the reference C-DU configuration. In response to the detection or initiation 316, the UE 102 sends 322 an RRC reconfiguration complete message for the C-SN 106A to the MN 104A. The UE 102 can send 322 the RRC reconfiguration complete message before, during or after the random access procedure. The DU 174 of the C-SN 106A after the random access procedure sends 320 an Access Success message to the CU 172 of the C-SN 106A. The Access Success message includes the Cell ID that the UE 102 accesses successfully.

The UE 102 may include the RRC reconfiguration complete message in an MN RRC message and transmit the MN RRC message at the event 322. The MN RRC message in some implementations can be an RRCReconfigurationComplete message or an ULInformationTransferMRDC message defined in 3GPP TS 38.331 release 17 or later specifications. In some implementations, the UE 102 may indicate, in the MN RRC message, that the UE 102 has executed one of the C-SN configuration(s) by including a configuration ID corresponding to the particular C-SN configuration. The MN 104A can use the configuration ID to identify or determine the ID of the C-PSCell (e.g., the PCI and/or the CGI of the C-PSCell 126A) and/or the C-SN if the MN 104A performs multiple CPA procedures with different C-SNs. The MN 104A can also use the configuration ID to identify or determine the C-SN configuration or the CG-Config IE including the C-SN configuration.

In response to or after receiving 322 the RRC reconfiguration complete message, the MN 104A can send 324 the RRC reconfiguration complete message in a SN message to the CU 172 of the C-SN 106A. In some implementations, the SN message can be a SgNB Reconfiguration Complete or S-Node Reconfiguration Complete message. In other implementations, the SN message can be an RRC Transfer message. In yet other implementations, the SN message can be a dedicated (specifically defined for the purposes of this procedure) interface message (e.g., XnAP or X2AP message) defined in 3 GPP 38.423 or 36.423 release 17 or future specifications.

In some implementations, the random access procedure can be a four-step random access procedure or a two-step random access procedure. In other implementations, the random access procedure can be a contention-based random access procedure or a contention-free random access procedure. For example, the UE 102 may include an RRC reconfiguration complete message in a message 3 of the four-step random access procedure or in a message A of the two-step random access procedure.

In response to or after receiving 322 the RRC reconfiguration complete message, the MN 104A applies 326 the corresponding conditional MN configuration. In response to applying 326 the corresponding conditional MN configuration, the MN 104A may transmit 328 an RRC reconfiguration message including configuration parameters to the UE 102. In some implementations, the configuration parameters 328 may reconfigure or release (values) of configuration parameters that the UE 102 uses to communicate with the MN 104A. In other implementations, the configuration parameters 328 may be new configuration parameters to configure the UE 102 to communicate with the MN 104A. In response to the RRC reconfiguration message 328, the UE 102 can transmit 330 an RRC reconfiguration complete message to the MN 104A. The MN 104A may in response transmit 332 an SN Status Transfer message to transfer uplink PDCP SN and HFN receiver status and/or downlink PDCP SN and HFN transmitter status for each of DRB(s) of the UE 102. In contrast to event 314, the MN 104A sends 334 a (non-early) SN Status Transfer message.

After the UE 102 successfully completes the 318 the random access procedure, the UE 102 communicates 336 with the MN 104A in accordance with the (updated) MN configuration and with the C-SN 106A via the first C-PSCell in accordance with the C-SN configuration configuring the first C-PSCell and/or the reference C-SN configuration. Specifically, the UE 102 communicates with the DU 174 of the C-SN 106A via the first C-PSCell in accordance with the C-DU configuration configuring the first C-PSCell and/or the reference C-DU configuration. The events 318, 320, 322, 324, 326, 328, 330, and 332 are collectively referred to in FIG. 3A as a CPAC execution procedure 394. The UE 102 may at a later time detect 338 that a condition for connecting to a second C-PSCell belonging to the C-SN 106A is met, similar to event 316. The UE 102, MN 104A, and C-SN 106A can therefore perform 395 a CPAC execution procedure for the second C-PSCell, similar to the procedure 394. If an additional C-SN (e.g., C-SN 2) is configured by the MN 104A, the UE 102 can at a later time (or before the event 338 instead) detect that a condition for connecting to a C-PSCell belonging to the C-SN 2 is met similar to the event 316 or 338. The UE 102, MN 104A, and the C-SN may therefore performs a CPAC execution procedure for the C-PSCell of the C-SN 2, similar to the event 394 or 395. The events 372, 374, 376, 306, 308, 310, 315, 316, 318, 320, 322, 324, 326, 328, 330, 332, 336, 338 and 395 are collectively referred to in FIG. 3A as a Selective activation preparation procedure 380.

With continued reference to FIG. 3A, the C-SN configuration in some implementations can be a complete and self-contained configuration (i.e., a full configuration). The C-SN configuration may include a full configuration indication (an information element (IE) or a field) that identifies the C-SN configuration as a full configuration. The UE 102 in this case can use the C-SN configuration to communicate with the SN 106A without relying on an SN configuration. In other implementations, the C-SN configuration can include a “delta” configuration, or one or more configurations that augment the reference C-SN configuration. In these cases, the UE 102 can use the delta C-SN configuration together with the reference C-SN configuration to communicate with the C-SN 106A.

The C-SN configuration can include multiple configuration parameters for the UE 102 to apply when communicating with the SN 106A via a C-PSCell 126A. The multiple configuration parameters may configure the C-PSCell 126A and zero, one, or more candidate secondary cells (C-SCells) of the SN 106A to the UE 102. The multiple configuration parameters may configure radio resources for the UE 102 to communicate with the C-SN 106A via the C-PSCell 126A and zero, one, or more C-SCells of the C-SN 106A. The multiple configuration parameters may configure zero, one, or more radio bearers. The one or more radio bearers can include an SRB and/or one or more DRBs.

In some implementations, the C-SN configuration can include a cell group configuration (CellGroupConfig) IE that configures the C-PSCell 126A and zero, one, or more C-SCells of the C-SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In some implementations, the reference C-SN configuration can include a cell group configuration (CellGroupConfig) IE that configures the C-PSCell 126A and zero, one, or more C-SCells of the C-SN 106A. In one implementation, the reference C-SN configuration includes a radio bearer configuration. In another implementation, the reference C-SN configuration does not include a radio bearer configuration. In various implementations, the reference C-SN configuration can be an RRCReconfiguration message, RRCReconfiguration-IEs, or the CellGroupConfig IE conforming to 3GPP Technical Specification (TS) 38.331.

Alternatively, the reference C-SN configuration is a dedicated (specifically defined for the purposes of this procedure) field or IE including the RRCReconfiguration message, RRCReconfiguration-IEs, or CellGroupConfig IE in a 3GPP release 18 or later release specification (e.g., TS 38.331). The full configuration indication may be a field or an IE conforming to 3GPP TS 38.331.

FIG. 3B depicts a scenario 300B, i.e., an MN-initiated conditional SN Change for continuous CPC, similar to FIG. 3A. The differences between FIG. 3B and FIG. 3A are described below.

The UE 102 is initially in dual connectivity 301 with MN 104A and S-SN 106B and communicates with S-SN 106B via a PSCell 126B in accordance with a first SN configuration (i.e., current SN configuration, serving SN configuration or source SN configuration). If the S-SN consists of a CU and a serving DU, the first SN configuration may include a first CU configuration (i.e., a serving CU configuration) that the UE 102 uses to communicate with the CU via the serving DU and a first DU configuration (i.e., a serving DU configuration) that the UE 102 uses to communicate with the serving DU. At a later time, the MN 104A determines to perform a conditional SN change (preparation) procedure with the C-SN 106A for continuous CPC.

Unlike the scenario 300A in FIG. 3A that the first reference C-SN configuration may be from the C-SN 0, the MN 104A, or the C-SN 1, the MN 104A obtains a first reference C-SN configuration from the S-SN 106B in the scenario 300B. In details, the MN 104A may transmit 340 an SN Modification Request message to the S-SN 106B to query a first reference C-SN configuration using a specific IE (e.g., SCG Configuration Query or a new defined IE specifically for continuous CPAC such as a Reference C-SN Configuration Query). The S-SN 106B in response transmits 342 an SN Modification Request Acknowledge message including the first reference C-SN configuration to the MN 104A. In some implementations, the first reference C-SN configuration is the first SN configuration. In other implementations, the first reference C-SN configuration is different from the first SN configuration. In yet other implementations, the first reference C-SN configuration is a subset of the first SN configuration. In some implementations, the first reference C-SN configuration is a full configuration. In other implementations, the first reference C-SN configuration is a delta configuration that augments the first SN configuration. In some implementations, the first reference C-SN configuration includes a reference CU configuration and a reference C-DU configuration.

The MN 104A transmits 305 an SN Addition Request message to the CU 172 of the C-SN 106A, similar to the event 304, and including the first reference C-SN configuration obtained in the event 342 from the S-SN 106B. The CU 172 of the C-SN 106A performs one or more 390 selective activation preparation procedure(s) as described in FIG. 3A to acquire C-DU configuration(s). The CU 172 of the C-SN 106A may generate 376 C-SN configuration(s) and/or a second reference C-SN configuration as described in FIG. 3A. In some implementations, the CU 172 of the C-SN 106A does not generate a second reference C-SN configuration as it adopts the first reference C-SN configuration. The DU 174 of the C-SN 106A in such implementations does not generate a second reference C-DU configuration as it adopts the first reference C-DU configuration. The CU 172 of the C-SN 106A in response transmits 307 an SN Addition Request Acknowledge message to the MN 104A including M₁ C-SN configuration(s) based on the reference C-SN configuration, similar to the event 306. In some implementations, each of the M₁ C-SN configuration(s) is a delta configuration augmenting the first reference C-SN configuration from the S-SN 106B. In some implementations, the C-SN 106A refrains from including a second reference C-SN configuration in the SN Addition Request Acknowledge message in the event 307. The MN 104A performs 392 an RRC reconfiguration procedure with the UE 102 as described in FIG. 3A. In cases where early data forwarding is needed, the MN 104A may transmit 344 an Interface message (e.g., Xn-U Address Indication or Data Address Indication message) to the S-SN 106B. The S-SN 106B then transmits 346 an Early Status Transfer message to the MN 104A and the MN 104A then transmits 314 an Early Status Transfer message to the CU 172 of the C-SN 106A.

In some implementations, based on the determination to perform continuous CPAC, the MN 104A also determines to configure additional N−1 C-SN(s) for the MN-initiated CPC, as described in FIG. 3A. N is a positive integer larger than 1. The interactions between the MN 104A, the C-SN 2, . . . , N, and the UE 102 are similar to the interactions between the MN 104A, the C-SN 1 and the UE 102 as described above for the events 305, 307, and 392 and as described in FIG. 3A.

Similar to FIG. 3A, the UE 102 later detects 316 that a condition for connecting to the first C-PSCell is met and performs a random access procedure on the first C-PSCell in response to the detection with the DU 174 of the C-SN 106A. The UE 102, MN 104A, and C-SN 106A perform the CPAC execution procedure 394. After (e.g., in response to) the procedure 394, the MN 104A transmits 348 an SN Release Request message (e.g., SgNB Release Request or S-Node Release Request message) for the UE 102 to the S-SN 106B. The S-SN 106B in response stops communicating with the UE 102 and transmits 350 an SN Release Request Acknowledge message (e.g., SgNB Release Request Acknowledge or S-Node Release Request Acknowledge message) to the MN 104A. In some implementations, if the S-SN 106B has prepared a C-SN configuration for continuous CPAC, the MN 104A can include, in the SN Release Request message, an indicator or a cause value indicating that the SN Release procedure concerns continuous CPAC. The S-SN 106B therefore does not expect a follow-up UE Context Release procedure from the MN 104A (i.e., the MN 104A does not transmit a UE Context Release message to the S-SN 106B after the SN Release Request message). Upon receiving the SN Release Request message, indicator or cause value, the S-SN 106B keeps the UE context and/or the UE-associated signaling connections between MN 104A and S-SN 106B for UE 102. In cases where data forwarding is needed, the MN 104A may transmit 351 an Interface message (e.g., Xn-U Address Indication or Data Address Indication message) to the S-SN 106B. The S-SN 106B then may transmit 352 an SN Status Transfer message to the MN 104A and the MN 104A then may transmit 334 an SN Status Transfer message to the CU 172 of the C-SN 106A. In some implementations, for example, if the S-SN 106B has not prepared a C-SN configuration for continuous CPAC, the MN 104A transmits 356 a UE Context Release message to the S-SN 106B. The events 348, 350, 351, 352, 334, and 356 can be collectively referred to as an SN Release and SN Status Transfer procedure 396.

FIG. 3C depicts a scenario 300C, i.e., an SN-initiated conditional SN change for continuous CPC, similar to FIGS. 3A and 3B. The differences between FIG. 3C and FIGS. 3A and 3B are described below.

The S-SN 106B at some time point determines to initiate a conditional SN change (preparation) procedure for one or more C-SNs for continuous CPC. The S-SN 106B can make this determination based on measurement result(s) from the UE 102, for example. In some implementations, the UE 102 performs measurements on cells of the one or more C-SNs and transmits the measurement result(s) to the S-SN 106B in accordance with a measurement configuration in the first SN configuration. In response to the determination, the S-SN 106B transmits 303 an SN Change Required message including a Target SN ID of the C-SN 106A, a CG-Config IE for the C-SN 106A, and a first reference C-SN configuration. In some implementations, the S-SN 106B includes, in the SN Change Required message, CPC information for the C-SN 106A. For example, the CPC information (e.g., Conditional PSCell Change Information Required IE) includes an IE indicating the maximum number of PSCells that the C-SN 106A may prepare. In such cases, the S-SN 106B includes the CG-Config IE in the CPC information. The first reference C-SN configuration in the SN Change Required message 303, is similar to the first reference C-SN configuration in the event 342. In some implementations, the S-SB 106B includes the first reference C-SN configuration in the CG-Config IE. In other implementations, the S-SN 106B includes the first reference C-SN configuration in a X2AP/XnAP IE of the SN Change Required message, different from an X2AP/XnAP IE that carries the CG-Config IE. In some implementations, the SN Change Required message includes a second indication (e.g., Selective Activation Indication IE) for continuous CPC for the UE 102. In some implementations, the S-SN 106B includes, in the CG-Config IE, triggering condition configuration(s) configuring the condition for the UE 102 to detect in the event 316.

After receiving the SN Change Required message, the MN 104A transmits 305C a SN Addition Request message to the CU 172 of the C-SN 106A, similar to the event 304 or 305. In the scenario 300A and 300B, the MN 104A derives an ID of the C-SN 106A based on the measurement results (received from the UE 102) and association information preconfigured in the MN 104A. For example, the association information indicates which cell is associated with which base station. In the scenario 300C, the MN 104A transmits the SN Addition Request message 305 to the C-SN 106A based on the Target SN ID of the C-SN 106A. In some implementations, the MN 104A generates an inter-node RRC message (i.e., CG-ConfigInfo IE) based on the CG-Config IE and includes the CG-ConfigInfo IE in the SN Addition Request message. In some implementations, the CG-Config IE includes 1) a candidateCellInfoListSN IE including the measurement results for one or more cells (e.g., cell(s) 126A and/or 126C) of the C-SN 106A and/or 2) a candidateCellListCPC IE indicating one or more cells (e.g., cell(s) 126A and/or 126C) that the S-SN 106B proposes for the C-SN 106A to consider as C-PSCell(s). The MN 104A includes the candidateCellInfoListSN IE and/or candidateCellListCPC IE in the CG-ConfigInfo IE. In some implementations, the CG-Config IE includes triggering condition configuration(s) (e.g., CondReconfigExecCondSCG IE(s)) for connecting the one or more cells. Alternatively, the MN 104A includes the triggering condition configuration(s) in a separate X2AP/XnAP IE of the SN Addition Request message. In other implementations, the MN 104A refrains from including the triggering condition(s) in the SN Addition Request message.

In some implementations, the MN 104A includes the first reference C-SN configuration in the SN Addition Request message in the event 305C, as described for the event 304 or 305. In some implementations, the MN 104A includes a first indication (e.g., Selective Activation Indication IE) for continuous CPAC in the SN Addition Request message in the event 305C based on or in response to the second indication. In some implementations, if the MN 104A does not support the SN-initiated conditional SN change (preparation) procedure for continuous CPC and receives a SN Change Required message for continuous CPAC from a SN (e.g., the SN Change Required message in the event 303), the MN 104A can transmit a SN Change Refuse message to the SN, (e.g., the S-SN 106B). In such cases, the MN 104A may support the SN-initiated conditional SN change (preparation) procedure for non-continuous CPC (e.g., 3GPP Release 17 CPC).

In some implementations, the S-SN 106B is allowed to initiate such conditional SN change (preparation) procedure for continuous CPC with the MN 104A because the S-SN 106B may have received an SN Addition Request message or an SN Modification Request message including an indication (e.g., Selective Activation Indication IE) from the MN 104A before or during the event 301. Based on the indication, the S-SN 106B determines that the MN 104A allows the S-SN 106B to initiate a SN-initiated conditional SN change (preparation) procedure for continuous CPC with the MN 104A. Thus, the S-SN 106B determines to transmit or transmits the SN Changed Required message in the event 303. If the S-SN 106B does not receive the indication, the S-SN 106B refrains from initiating a SN-initiated conditional SN change (preparation) procedure for continuous CPC with the MN 104A. In such a case, the S-SN 106B refrains from transmitting a SN Change Required message like the message in the event 303.

The CU 172 of the C-SN 106A performs one or more 390 selective activation preparation procedure(s) as described in FIG. 3A to acquire C-DU configuration(s). The CU 172 of the C-SN 106A may generate 376 C-SN configuration(s) and/or a second reference C-SN configuration as described in FIG. 3A. The CU 172 of the C-SN 106A may generate 376 C-SN configuration(s) and/or a second reference C-SN configuration as described in FIG. 3A. The CU 172 of the C-SN 106A, in response to the SN Addition Request message, transmits 307 an SN Addition Request Acknowledge message to the MN 104A including M₁ C-SN configuration(s), similar to the event 306. The MN 104A then transmits the M₁ C-SN configuration(s) to the UE 102 in the procedure 310. In some implementations, based on the reference C-SN configuration, the C-SN 106A generates each of the M₁ C-SN configuration(s) as a delta configuration augmenting the reference C-SN configuration. Unlike the scenarios 300A and 300B, in the RRC reconfiguration message of the procedure 392, each of the conditional (re)configuration field(s)/IE(s) includes the triggering condition configuration received from the S-SN 106B. After receiving the SN Addition Request Acknowledge message or after or while performing the procedure 392 with the UE 102, the MN 104A transmits 311 an SN Change Confirm message to the S-SN 106B.

In some implementations, the Target SN ID(s) include ID(s) of the C-SN(s) 2, . . . , N for the SN-initiated conditional SN change (preparation) procedure for continuous CPC with the C-SN(s) 2, . . . , N. Thus, the MN 104A can transmit a SN Addition Request message to each of the C-SN(s) 2, . . . , N as described above.

Turning to FIGS. 4A-4B, scenarios 400A-400B may each be similar to any one of the scenarios 300A-300C. However, the scenarios 400A-400B involve an intra-base station CPC while the scenarios 300A-300C concern CPA or inter-base station CPC.

FIG. 4A depicts a scenario 400A, i.e., an intra-SN continues CPC. In the scenario 400A the UE 102 initially operates 402 in DC with the MN 104A and SN 106A and communicates with the S-DU 174A and the CU 172 of the SN 106A via a PSCell 126A in accordance with a first SN configuration, similar to the event 301. The first SN configuration may include a first CU configuration (i.e., a serving CU configuration) that the UE 102 uses to communicate with the CU 172 via the S-DU 174A and a first DU configuration (i.e., a serving DU configuration or an S-DU configuration) that the UE 102 uses to communicate with the S-DU 174A on the cell 126A.

At a later time, the CU 172 of the SN 106A determines to configure C-PSCells 1, . . . , M₁, M₁ is a positive integer to the UE 102 for intra-SN continuous CPC at the T-DU 174B. The CU 172 of the SN 106A can make this determination based on measurement result(s) from the UE 102, for example. In some implementations, the UE 102 performs measurements on cells of the SN 106A and transmits the measurement result(s) to the SN 106A in accordance with a measurement configuration in the first SN configuration. In one implementations, the UE 102 transmits 462 a measurement report including the measurement results to the MN 104A. The UE 102 may transmit the measurement report in an ULInformationTransferMRDC message to the MN 104A. The MN 104A then transmits 464 the measurement report to the CU 172 of the SN 106A. The MN 104A may transmit the measurement report of the event 464 in an RRC Transfer message to the CU 172 of the SN 106A. In other implementations, the UE 102 transmits 465 a measurement report to the S-DU 174A of the SN 106A. The S-DU 174A then transmits 467 the measurement report in a DU-to-CU message to the CU 172. The DU-to-CU message can be a UL RRC Message Transfer message. In response to the determination, the CU 172 and S-DU 174A of the SN 106A, the MN 104A, and the UE 102 may, in addition to the event 490, perform 480 a selective activation preparation procedure similar to the event 380 as described in the FIG. 3A to prepare one or more C-DU or C-SN configuration(s) served by the S-DU 174A. The first reference C-DU configuration can be the same as the first DU configuration. The event 480 does not include events similar to the events 306, 315, or 332 as the SN 106A operates in DC with the MN 104A already for the UE 102. The CU 172 of the SN 106A transmits the RRC reconfiguration message including the C-SN configuration(s) to the MN 104A using an SN Modification Required message instead of an SN Addition Request Acknowledge message as in FIG. 3A. The CU 172 of the SN 106A performs the selective activation preparation procedure(s) with the S-DU 174A using the UE Context Modification Request message and the UE Context Modification Response message.

The CU 172 of the SN 106A performs one or more 490 selective activation preparation procedure(s) with the T-DU 174B to acquire the M₁ C-DU configuration(s) similar to the event 390. The first reference C-DU configuration can be the same as the first DU configuration. The CU 172 of the SN 106A may generate 476 C-SN configuration(s) and/or a second reference C-SN configuration as described in the event 376 in the FIG. 3A. The CU 172 of the SN 106A generates a first SN RRC reconfiguration message including the M₁ C-SN configuration(s) (i.e., C-SN configuration(s) 1, . . . , M₁) and/or the reference C-SN configuration, similar to the event 308, and transmits 406 the first SN RRC reconfiguration message to the MN 104A. The C-SN configuration(s) 1, . . . , M₁ configure or are associated with the C-PSCells 1, . . . , M₁, respectively. In some implementations, the reference C-SN configuration included in the first SN RRC reconfiguration message is the first reference C-SN configuration that the CU 172 of the SN 106A generates based on the first reference C-DU configuration as described in FIG. 3A. In other implementations, the reference C-SN configuration included in the first SN RRC reconfiguration message is the second reference C-SN configuration that the CU 172 of the SN 106A generates based on the second reference C-DU configuration as described in FIG. 3A. In some implementations, each of the M₁ C-SN configuration(s) is a delta configuration augmenting the reference C-SN configuration and each of the M₁ C-DU configuration(s) is a delta configuration augmenting the reference C-DU configuration. In some implementations, the reference C-SN configuration is the first SN configuration and the reference C-DU configuration is the first DU configuration. In other implementations, the reference C-SN configuration is different from the first SN configuration and the reference C-DU configuration is different from the first DU configuration. In yet other implementations, the reference C-SN configuration is a subset of the first SN configuration and the reference C-DU configuration is a subset of the first DU configuration. In some implementations, the reference C-SN configuration is a full configuration. The reference C-DU configuration can be a full configuration. In other implementations, the reference C-SN configuration is a delta configuration that augments the first SN configuration and the reference C-DU configuration is a delta configuration that augments the first DU configuration. In some implementations, the CU 172 of the SN 106A transmits a SN message (e.g., SN Modification Required message) including the first SN RRC reconfiguration message to the MN 104A in the event 406. The MN 104A in turn transmits 408 the first SN RRC reconfiguration message to the UE 102. The UE 102, in response to the SN RRC reconfiguration message, the UE 102 transmits 410 a first SN RRC reconfiguration complete message to the MN 104A, which in turn transmits 412 the first SN RRC reconfiguration complete message to the CU 172 of the SN 106A. In some implementations, the MN 104A may include the first SN RRC reconfiguration complete message in the event 412 in an SN Reconfiguration Complete message.

In some implementations, the MN 104A generates an MN RRC message (e.g., RRC reconfiguration message) including the first SN RRC reconfiguration message and transmits the MN RRC message to the UE 102 in the event 408. In such cases, the UE 102 transmits an MN RRC response message (e.g., RRC reconfiguration complete message) including the first SN RRC reconfiguration complete message to the MN 104A in the event 410 in response to the MN RRC message.

The UE 102 may later detect 416 that a condition for connecting to a first C-PSCell (e.g., the C-PSCell 1) is met. In response to the detection, the UE 102 performs 418 a random access procedure with the T-DU 174B of the SN 106A via the first C-PSCell. The UE 102 performs the random access procedure in accordance with the random access configurations of the C-DU configuration and/or the reference C-DU configuration. The UE 102 transmits 422 a second SN RRC reconfiguration complete message to the MN 104A, which in turn transmits 424 the second SN RRC reconfiguration complete message to the CU 172 of the SN 106A. In some implementations, the second SN RRC reconfiguration complete message may include a configuration ID indicating the C-SN configuration 1 for the first C-PSCell to the MN 104A. In some implementations, the UE 102 includes the second SN RRC reconfiguration complete message in an ULInformationTransferMRDC message. In some implementations, the MN 104A transmits a SN message (e.g., RRC Transfer message) including the second SN RRC reconfiguration complete message to the SN 106A in the event 424. The T-DU 174B of the SN 106A after the random access procedure sends 420 an Access Success message to the CU 172 of the SN 106A. The Access Success message includes the Cell ID that the UE 102 accesses successfully.

After successfully completing the random access procedure, the UE 102 in DC communicates 436 with the MN 104A and the SN 106A and communicates with the SN 106A via the first C-PSCell in accordance with the C-SN configuration. Specifically, the UE 102 communicates with the T-DU 174B of the SN 106A via the first C-PSCell in accordance with the C-DU configuration configuring the first C-PSCell and/or the reference C-DU configuration. The events 418, 420, 422, 424 and 436 can be collectively referred to as a (intra-SN) CPC execution procedure 494. The CU 172 of the SN 106A may transmit 426 a UE Context Modification Request message to the S-DU 174A to stop data transmission for the UE 102. The S-DU 174A in response transmits 428 a UE Context Modification Response message to the CU 172. In some implementations, the S-DU 174A is configured with the selective activation preparation procedure as described in event 480. The CU 172 in such implementations refrain from transmitting 430 a UE Context Release Command message to the S-DU 174A following the UE context modification procedure. In other implementations, the S-DU 174A is not configured with the selective activation preparation procedure as described in event 480. The CU 172 in such implementations transmits 430 a UE Context Release Command message to the S-DU 174A following the UE context modification procedure. The S-DU 174A releases the UE context and resources reserved for the UE 102 and transmits 432 a UE Context Release Complete message to the CU 172. The events 426, 428, 430 and 432 can be collectively referred to as the UE context release procedure 498. The UE 102 may later detect 438 that a condition for connecting to a second C-PSCell is met, similar to the event 418. The UE 102, MN 104A, and SN 106A performs 495 the (intra-SN) CPC execution procedure for the second C-PSCell similar to the event 494.

Referring next to FIG. 4B. FIG. 4B depicts a scenario 400B similar to the scenario 400A and the differences are described below. After the one or more selective activation preparation procedure(s) 490 and the C-SN configuration(s) and/or the reference C-SN configuration generating procedure 476, the CU 172 of the SN 106A transmits 407 the first SN RRC reconfiguration message similar to the event 406 but to the S-DU 174A (i.e., the source or serving DU) instead of the MN 104A. The CU 172 may transmit the first SN RRC reconfiguration message in a DL RRC Message Transfer message to the S-DU 174A at the event 407. The S-DU 174A subsequently transmits 409 the first SN RRC reconfiguration message to the UE 102. The UE 102, in response, transmits 411 the first RRC reconfiguration complete message to the S-DU 174A of the SN 106A. The S-DU 174A transmits 413 the first RRC reconfiguration complete message to the CU 172 of the SN 106A. The S-DU 174A may transmit the first RRC reconfiguration complete message in a UL RRC Message Transfer message to the CU 172 at the event 413. In response to the detection 416, the UE 102 performs 418 the random access procedure with the T-DU 174B of the SN 106A via the first C-PSCell and transmits 421 the second SN RRC reconfiguration complete message to the T-DU 174B of the SN 106A directly, e.g., via the SRB3. The T-DU 174B transmits 423 the second SN RRC reconfiguration complete message to the CU 172 of the SN 106A. The T-DU 174B can transmit the second SN RRC reconfiguration complete message in a UL RRC Message Transfer message to the CU 172.

The events 418, 420, 421, 423, and 436 can be collectively referred to as a (intra-SN) CPC execution procedure 496. The CU 172 and the S-DU 174A of the SN 106A may perform 498 the UE context release procedure after the event 496. The UE 102 may later detect 438 that a condition for connecting to a second C-PSCell is met similar to the event 418. The UE 102, MN 104A, and SN 106A perform 497 the (intra-SN) CPC execution procedure for the second C-PSCell, similar to the event 496.

In some implementations, the SN 106A determines to update the reference C-SN configuration (i.e., a first reference C-SN configuration). In response to the determination, the CU 172 of the SN 106A performs a selective activation preparation procedure or a UE context modification procedure with the T-DU 174B to acquire the updated reference C-DU configuration and/or updated C-DU configuration(s) and generates the updated reference C-SN configuration (i.e., a second reference C-SN configuration) and/or updated C-SN configuration(s) accordingly. The SN 106A transmits a second reference C-SN configuration and/or the updated C-SN configuration(s), similar to the event 406-408 or 407-409. In cases where the second reference C-SN configuration is a full configuration, the UE 102 replaces the first reference C-SN configuration with the second reference C-SN configuration. In case that a condition for connecting to a C-PSCell is met, similar to the event 416 or 438, the UE 102 performs a random access procedure on the C-PSCell and applies the C-SN configuration configuring or associated with the C-PSCell and the second C-SN configuration to communicate with the SN 106A, similar to the events 418 and 436, 494, 495, 496, or 497.

In cases where the second reference C-SN configuration is a delta configuration, the UE 102 augments the first reference C-SN configuration with the second reference C-SN configuration to obtain an updated reference C-SN configuration. In case that a condition for connecting to a C-PSCell is met similar to event 416 or 438, the UE 102 performs a random access procedure on the C-PSCell and applies the C-SN configuration (configuring or associated with the C-PSCell) and the updated C-SN configuration to communicate with the SN 106A, similar to the event 418 and the event 436, 494, 495, 496, or 497, respectively.

After the UE 102 applies the C-SN configuration as described above, the applied C-SN configuration becomes a SN configuration (i.e., serving or source SN configuration) or a portion of the SN configuration. After (e.g., in response to) applying the C-SN configuration, the UE 102 refrains from removing the conditional (re)configuration field(s)/IE(s) associated with the reference C-SN configuration.

In some implementations, the SN 106A may generate a C-SN configuration configuring a particular C-PSCell for non-continuous CPAC and transmits the C-SN configuration to the UE 102, similar to the events 406 and 408 or the event 409. In such cases, the C-SN configuration for non-continuous CPAC is not associated with a reference C-SN configuration. In case that a condition for connecting to the particular C-PSCell is met, similar to the event 416 or 438, the UE 102 performs a random access procedure on the particular C-PSCell and applies the C-SN configuration to communicate with the SN 106A on the particular C-PSCell, similar to the event 318 and the event 336, 394, or 395, respectively. After applying the C-SN configuration, the UE 102 removes the conditional (re)configuration field(s)/IE(s).

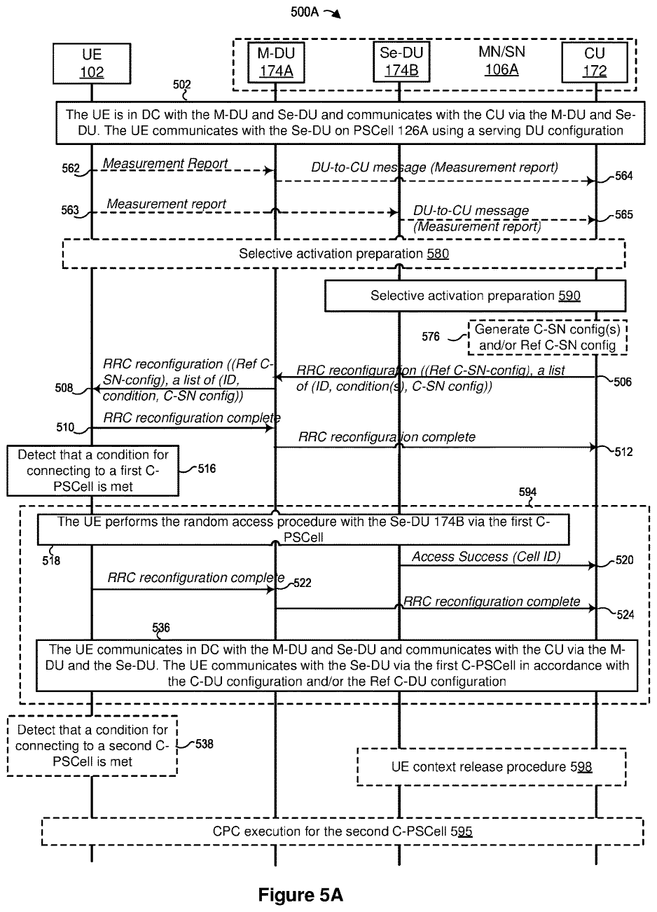

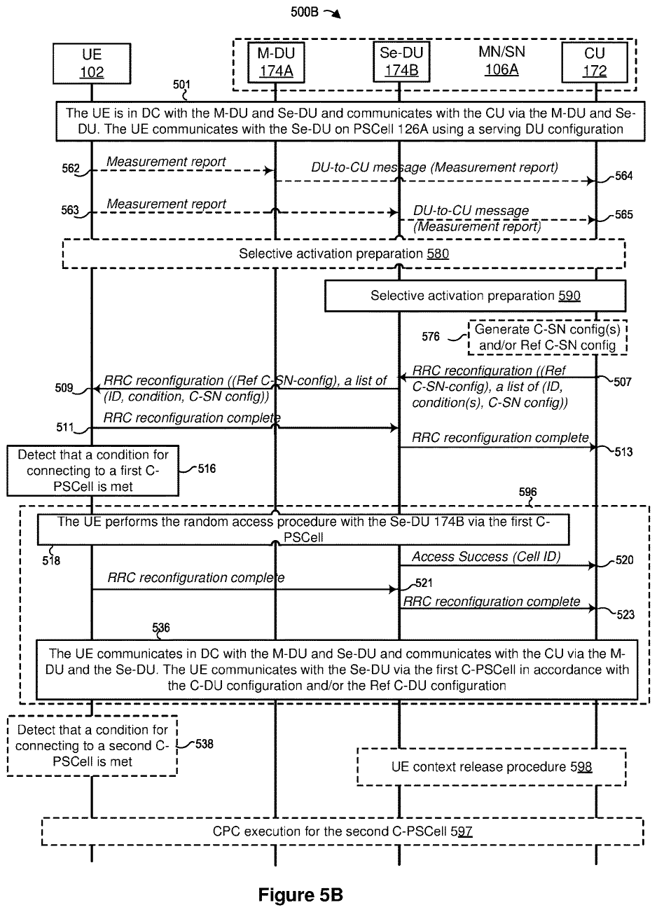

Turning to FIGS. 5A-5B, scenarios 500A-500B may each be similar to any one of the scenarios 300A-300C or 400A-400B. However, the scenarios 500A-500B involve an intra-base station dual connectivity with CPC while the scenarios 400A-400B concern inter-base station dual connectivity and intra-base station CPC.

FIG. 5A depicts a scenario 500A, i.e., an intra-base station DC and intra-secondary-DU continuous CPC. In the scenario 500A the UE 102 initially operates 502 in DC with the M-DU (e.g., Master DU) 174A and Se-DU 174B (e.g., Secondary DU) and communicates with the CU 172 via the M-DU 174A and Se-DU 174B. The CU 172, M-DU 174A, and Se-DU 174B belongs to the base station 106A and serves as both the MN and the SN for the UE 102. The UE communicates with the Se-DU 174B on PSCell 126A using a serving DU configuration (or a first DU configuration), similar to the event 402, 401 or 301. The first DU configuration can be part of the first SN configuration that the UE 102 uses to communicate with the Se-DU 174B and the CU 172 of the base station 106A.

At a later time, the CU 172 of the base station 106A determines to configure C-PSCells 1, . . . , M₁, M₁ is a positive integer to the UE 102 for intra-SN continuous CPC at the Se-DU 174B. The CU 172 of the base station 106A can make this determination based on measurement result(s) from the UE 102, for example. In some implementations, the UE 102 performs measurements on cells of the base station 106A and transmits the measurement result(s) to the base station 106A in accordance with a measurement configuration. In one implementations, the UE 102 transmits 562 a measurement report including the measurement results to the M-DU 174A. The UE 102 may transmit the measurement report in a DU-to-CU message (e.g., ULInformationTransferMRDC message) to the M-DU 174A. The M-DU 174A then transmits 564 the measurement report to the CU 172 of the base station 106A. The M-DU 174A may transmit the measurement report of the event 564 in an UL RRC Message Transfer message to the CU 172. In other implementations, the UE 102 transmits 563 a measurement report to the Se-DU 174B of the base station 106A. The Se-DU 174B then transmits 565 the measurement report in a DU-to-CU message (e.g., UL RRC Message Transfer message) to the CU 172. In response to the determination, the CU 172, the M-DU 174A, and the UE 102 may, in addition to the event 590, perform 580 a selective activation preparation procedure similar to the event 480 as described in the FIG. 4A to prepare one or more C-DU configuration(s) served by the M-DU 174A for continuous mobility within the M-DU. The first reference C-DU configuration can be the same as the serving DU configuration.

The CU 172 of the base station 106A performs one or more 590 selective activation preparation procedure(s) with the Se-DU 174B to acquire the M: C-DU configuration(s) similar to the event 490 or 390. The first reference C-DU configuration can be the same as the first DU configuration. The CU 172 of the base station 106A may generate 576 C-SN configuration(s) and/or a second reference C-SN configuration as described in the event 376 in the FIG. 3A. The CU 172 of the base station 106A generates a first SN RRC reconfiguration message including the M₁ C-SN configuration(s) (i.e., C-SN configuration(s) 1, . . . , M₁) and/or the reference C-SN configuration, similar to the event 308, and transmits 506 the first SN RRC reconfiguration message to the M-DU 174A (e.g., in a DL RRC Message Transfer message). The C-SN configuration(s) 1, . . . , M₁ configure or are associated with the C-PSCells 1, . . . , M₁, respectively. The M-DU 174A in turn transmits 408 the first SN RRC reconfiguration message to the UE 102. The UE 102, in response to the SN RRC reconfiguration message, the UE 102 transmits 510 a first SN RRC reconfiguration complete message to the M-DU 174A, which in turn transmits 512 the first SN RRC reconfiguration complete message to the CU 172 of the base station 106A. In some implementations, the M-DU 174A may include the first SN RRC reconfiguration complete message in the event 512 in an UL RRC Message Transfer message.

In some implementations, the base station 106A generates an MN RRC message (e.g., RRC reconfiguration message) including the first SN RRC reconfiguration message and transmits the MN RRC message to the UE 102 via the M-DU 174A in the event 506-508. In such cases, the UE 102 transmits an MN RRC response message (e.g., RRC reconfiguration complete message) including the first SN RRC reconfiguration complete message to the base station 106A via the M-DU 174A in the event 510-512 in response to the MN RRC message.

The UE 102 may later detect 516 that a condition for connecting to a first C-PSCell (e.g., the C-PSCell 1) is met. In response to the detection, the UE 102 performs 518 a random access procedure with the Se-DU 174B of the base station 106A via the first C-PSCell. The UE 102 performs the random access procedure in accordance with the random access configurations of the C-DU configuration and/or the reference C-DU configuration. The UE 102 transmits 522 a second SN RRC reconfiguration complete message to the M-DU 174A, which in turn transmits 524 the second SN RRC reconfiguration complete message (e.g., in a UL RRC Message Transfer message) to the CU 172 of the base station 106A. In some implementations, the UE 102 includes the second SN RRC reconfiguration complete message in an ULInformation TransferMRDC message. The Se-DU 174B of the base station 106A after the random access procedure sends 520 an Access Success message to the CU 172 of the base station 106A. The Access Success message includes the Cell ID that the UE 102 accesses successfully.

After successfully completing the random access procedure, the UE 102 communicates 536 in DC with the M-DU 174A and the Se-DU 174B and communicates with the CU 172 via the M-DU 174A and the Se-DU 174B. The UE communicates with the Se-DU 174B via the first C-PSCell in accordance with the C-DU configuration and/or the Ref C-DU configuration. The events 518, 520, 522, 524 and 536 can be collectively referred to as a (intra-base station dual connectivity) CPC execution procedure 594. The CU 172 may perform a UE context release procedure 598 with the Se-DU 174B to stop transmission at the initial PSCell (i.e., PSCell 126A) and release resources and/or configuration for communicating with the UE 102 on that PSCell. In some implementations, the CU 172 refrain from performing 598 as the initial PSCell is also included as one of the C-PSCell(s). The UE 102 may later detect 538 that a condition for connecting to a second C-PSCell is met, similar to the event 518. The UE 102, M-DU 174A, Se-DU 174B, and the CU 172 of the base station 106A performs 595 the (intra-SN) CPC execution procedure for the second C-PSCell similar to the event 594.

Referring next to FIG. 5B. FIG. 5B depicts a scenario 500B similar to the scenario 500A and the differences are described below. After the one or more selective activation preparation procedure(s) 590 and the C-SN configuration(s) and/or the reference C-SN configuration generating procedure 576, the CU 172 of the base station 106A transmits 507 the first SN RRC reconfiguration message similar to the event 506 but to the Se-DU 174B (i.e., the serving (Secondary) DU) instead of the M-DU 174A. The CU 172 may transmit the first SN RRC reconfiguration message in a DL RRC Message Transfer message to the Se-DU 174B at the event 507. The Se-DU 174B subsequently transmits 509 the first SN RRC reconfiguration message to the UE 102. The UE 102, in response, transmits 511 the first RRC reconfiguration complete message to the Se-DU 174B of the base station 106A. The Se-DU 174B transmits 513 the first RRC reconfiguration complete message to the CU 172 of the base station 106A. The Se-DU 174B may transmit the first RRC reconfiguration complete message in a UL RRC Message Transfer message to the CU 172 at the event 513. In response to the detection 516, the UE 102 performs 518 the random access procedure with the Se-DU 174B of the base station 106A via the first C-PSCell and transmits 521 the second SN RRC reconfiguration complete message to the Se-DU 174B of the base station 106A directly, e.g., via the SRB 3. The Se-DU 174B transmits 523 the second SN RRC reconfiguration complete message to the CU 172 of the base station 106A. The Se-DU 174B can transmit the second SN RRC reconfiguration complete message in a UL RRC Message Transfer message to the CU 172.

The events 518, 520, 521, 523, and 536 can be collectively referred to as a (intra-base station DC) CPC execution procedure 596. The CU 172 and the Se-DU 174A of the base station 106A may perform 598 the UE context release procedure after the event 596. The UE 102 may later detect 538 that a condition for connecting to a second C-PSCell is met similar to the event 518. The UE 102, M-DU 174A, Se-DU 174B and CU 172 of the base station 106A perform 597 the (intra-SN) CPC execution procedure for the second C-PSCell, similar to the event 596.

In some implementations, the base station 106A determines to update the reference C-SN configuration (i.e., a first reference C-SN configuration). In response to the determination, the CU 172 of the base station 106A performs a selective activation preparation procedure or a UE context modification procedure with the Se-DU 174B (or the M-DU 174A) to acquire the updated reference C-DU configuration and/or updated C-DU configuration(s). The CU 172 generates the updated reference C-SN configuration (i.e., a second reference C-SN configuration) and/or updated C-SN configuration(s) accordingly. The base station 106A transmits a second reference C-SN configuration and/or the updated C-SN configuration(s) to the UE 102, similar to the event 506-508 or 507-509. In cases where the second reference C-SN configuration is a full configuration, the UE 102 replaces the first reference C-SN configuration with the second reference C-SN configuration. In case that a condition for connecting to a C-PSCell is met, similar to the event 516 or 538, the UE 102 performs a random access procedure on the C-PSCell and applies the C-SN configuration configuring or associated with the C-PSCell and the second C-SN configuration to communicate with the base station 106A, similar to the events 518 and 536, 594, 595, 596, or 597. The example implementations for the reference C-SN configuration and the reference C-DU configuration described in FIGS. 3A-3C and 4A-4B can be applied in the FIGS. 5A-5B if there is no conflict.

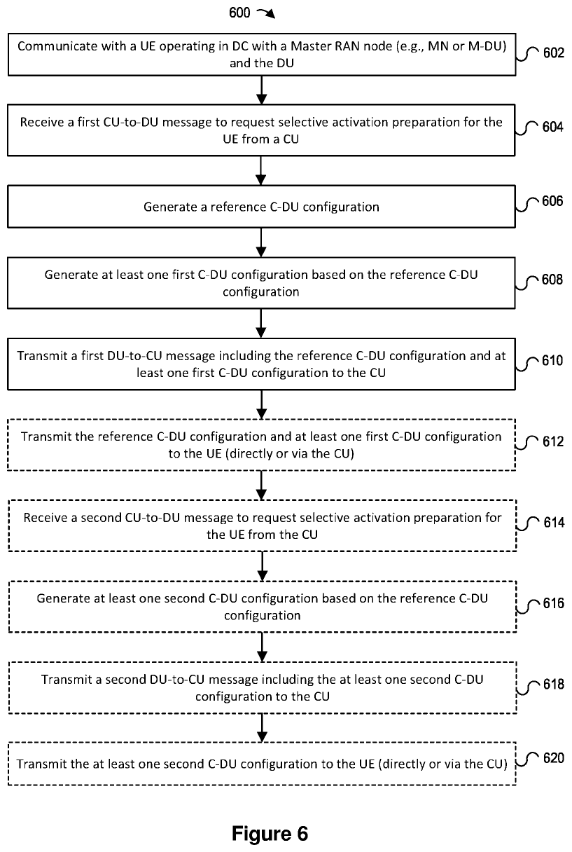

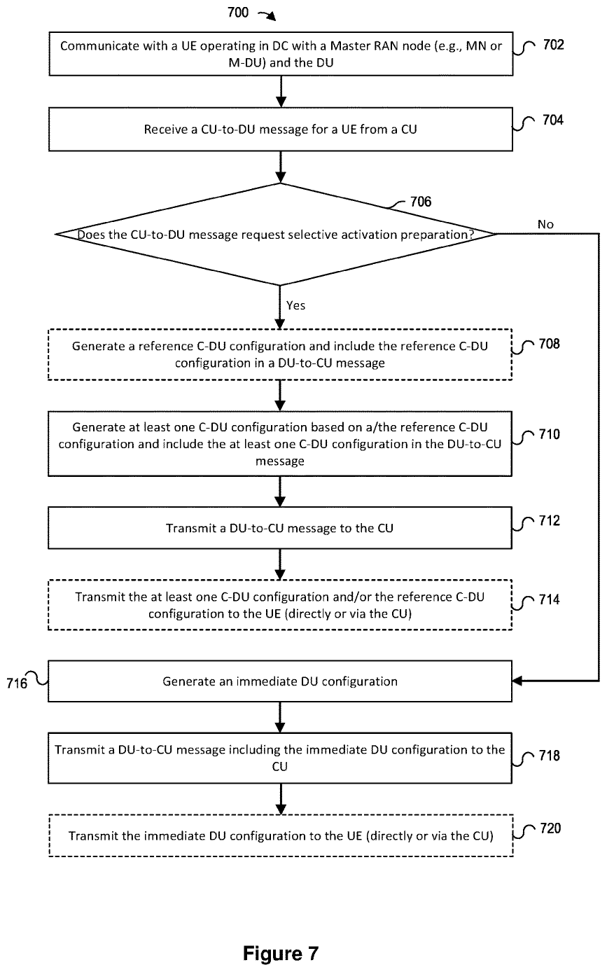

FIGS. 6-11D are flow diagrams depicting example methods that a base station (e.g., the base station 104A, 104B, 106A, or 106B) can implement to support continuous CPAC/selective activation procedures in accordance with the techniques of this disclosure. As indicated at various points throughout this disclosure, the example methods depicted in FIGS. 6-11D may be implemented during the scenarios 300A-300C, 400A-400B, 500A-500B described above.

FIG. 6 illustrates an example method 600, which can be implemented by a DU (e.g., the (Se-)DU 174B of the base station 106B or 106A), for configuring selective activation for a UE (e.g., the UE 102) and a CU (e.g., the CU 172 of the base station 106B or 106A).

The method 600 begins at block 602, where the DU communicates with a UE operating in DC with a Master RAN node (e.g., MN or M-DU) and the DU (e.g., events 301, 501, 502). At block 604, where the DU receives a first CU-to-DU message requesting selective activation preparation for the UE from the CU (e.g., events 372, 390, 490, 580, 590). At block 606, the DU generates a reference C-DU configuration. At block 608, the DU generates at least one first C-DU configuration (i.e., non-reference C-DU configuration) based on the reference C-DU configuration. At block 610, the DU transmits a first DU-to-CU message including the reference C-DU configuration and at least one first C-DU configuration to the CU (e.g., events 374, 390, 490, 590). At block 612, the DU transmits the reference C-DU configuration and at least one first C-DU configuration to the UE (e.g., events 509). In some alternative implementations, the DU transmits the reference C-DU configuration and at least one first C-DU configuration to the UE 102 via a Master RAN node (e.g., MN or M-DU) (e.g., events 390, 490, 590).

At block 614, the DU receives a second CU-to-DU message requesting selective activation preparation for the UE from the CU (e.g., events 372, 390, 490, 580, 590). At block 616, the DU generates at least one second C-DU configuration based on the reference C-DU configuration. At block 618, the DU transmits a second DU-to-CU message including the at least one second C-DU configuration to the CU (e.g., events 374, 390, 490, 580, 590). At block 620, the DU transmits the at least one second C-DU configuration (i.e., non-reference C-DU configuration) to the UE (e.g., events 509). In some alternative implementations, the DU transmits the at least one second C-DU configuration to the UE 102 via a Master RAN node (e.g., MN or M-DU) (e.g., events 390, 490, 590). In some implementations, the DU refrains from including the reference C-DU configuration in the second DU-to-CU message, which prevents the CU from transmitting the reference C-DU configuration to the UE. Thus, the UE, DU and CU can save power because of refraining from transmitting the reference C-DU configuration.

In some implementations, the DU communicates with the UE using a first serving DU configuration, before and/or when the receiving the first CU-to-DU message. In some implementations, the DU receives a first RRC message including the reference C-DU configuration and at least one first C-DU configuration from the CU and at block 612 transmits the first RRC message to the UE using the first serving DU configuration. In some implementations, the DU communicates with the UE using the first serving DU configuration, before and/or when the receiving the second CU-to-DU message. In such cases, the DU receives a second RRC message including the at least one second C-DU configuration from the CU and at block 620 transmits the second RRC message to the UE using the first serving DU configuration. In other implementations, the DU communicates with the UE using a second serving DU configuration, before and/or when the receiving the second CU-to-DU message. In such cases, the DU receives a second RRC message including the at least one second C-DU configuration from the CU and at block 620 transmits the second RRC message to the UE using the second serving DU configuration. The second serving DU configuration includes configuration parameters different from the first serving DU configuration. The second RRC message may not include the reference C-DU configuration.

In some implementations, the first RRC message and second RRC message are RRC reconfiguration messages. In some implementations, the first serving DU configuration and second serving DU configuration are cell group configurations (e.g., CellGroupConfig IEs). In other implementations, the first serving DU configuration and second serving DU configuration include configuration parameters in a Cell GroupConfig IE as defined in 3GPP specification 38.331.

In some implementations, the first CU-to-DU message may include an indication requesting selective activation preparation and the DU determines that the first CU-to-DU message requests selective activation preparation based on the indication. In some implementations, the second CU-to-DU message may include an indication requesting selective activation preparation and the DU determines that the second CU-to-DU message requests selective activation preparation based on the indication. In some implementations, the indication in the first CU-to-DU message and the indication in the second CU-to-DU message can be a dedicated (specifically defined for the purposes of this procedure in a relevant specification such as TS 38.473) IE. For example, the indication is an indicator specifically indicating that the first CU-to-DU message requests selective activation preparation.

In some implementations, the first CU-to-DU message and first DU-to-CU message are UE Context Modification Request message and UE Context Modification Response message, respectively. In some implementations, the second CU-to-DU message and second DU-to-CU message are UE Context Modification Request message and UE Context Modification Response message, respectively.

FIG. 7 illustrates an example method 700, which can be implemented by a DU (e.g., the (Se-)DU 174B of the base station 106B or 106A), for configuring selective activation for a UE (e.g., the UE 102) and a CU (e.g., the CU 172 of the base station 106B or 106A).

The method 700 begins at block 702, where the DU communicates with a UE operating in DC with a Master RAN node (e.g., MN or M-DU) and the DU (e.g., events 301, 501, 502). At block 704, the DU receives a CU-to-DU message for the UE from the CU (e.g., events 372, 390, 490, 580, 590). At block 706, the DU determines whether the CU-to-DU message requests selective activation preparation. If the DU determines that the CU-to-DU message requests selective activation preparation at block 706, the flow proceeds to block 708 where the DU generates a reference C-DU configuration and include the reference C-DU configuration in a DU-to-CU message. At block 710, the DU generates at least one C-DU configuration based on the reference C-DU configuration and include the at least one C-DU configuration in the DU-to-CU message. At block 712, the DU transmits the DU-to-CU message to the CU (e.g., events 374, 390, 490, 590). At block 714, the DU transmits the reference C-DU configuration and/or the at least one C-DU configuration (i.e., non-reference C-DU configuration) to the UE (e.g., events 509).

Otherwise, if the DU determines that the CU-to-DU message does not request selective activation preparation at block 706, the flow proceeds to block 716, where the DU generates an immediate DU configuration. At block 718, the DU transmits a DU-to-CU message including the immediate DU configuration to the CU. At block 720, the DU transmits the immediate DU configuration to the UE (e.g., events 509). In some alternative implementations, the DU transmits the immediate DU configuration to the UE 102 via a Master RAN node (e.g., MN or M-DU) (e.g., events 390, 490, 590). After transmitting the immediate DU configuration to the UE, the DU communicates with the UE using the immediate DU configuration.

In some implementations, the DU determines whether the CU-to-DU message requests selective activation preparation based on whether an indication is included in the CU-to-DU message. If the CU-to-DU message includes the indication, the DU determines that the CU-to-DU message requests selective activation preparation. Otherwise, if the CU-to-DU message does not include the indication, the DU determines that the CU-to-DU message does not request selective activation preparation. For example, the indication is an indicator specifically indicating that the first CU-to-DU message requests selective activation preparation.

In some implementations, the DU at block 702 communicates with the UE using a serving DU configuration. In some implementations, the DU at block 716 generates the immediate DU configuration as a delta configuration to augment the serving DU configuration.

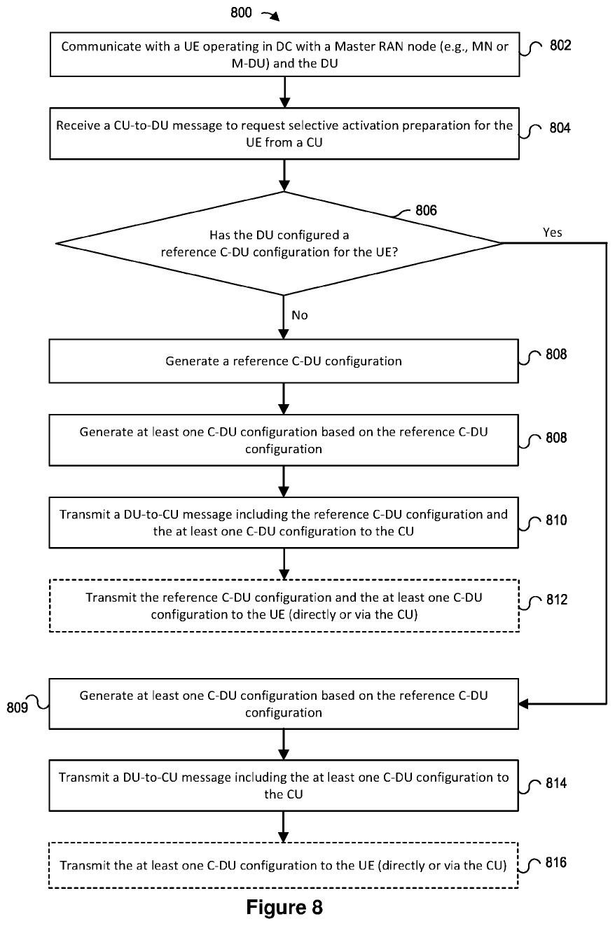

FIG. 8 illustrates an example method 800, which can be implemented by a DU (e.g., the (Se-)DU 174 of the base station 106B or 106A), for configuring selective activation for a UE (e.g., the UE 102) and a CU (e.g., the CU 172 of the base station 106B or 106A).

The method 800 begins at block 802, where the DU communicates with a UE operating in DC with a Master RAN node (e.g., MN or M-DU) and the DU (e.g., events 301, 501, 502). At block 804, the DU receives a CU-to-DU message to request selective activation preparation for the UE from the CU (e.g., events 372, 390, 490, 580, 590). At block 806, the DU determines whether the DU has configured a reference C-DU configuration for the UE, i.e., before receiving the CU-to-DU message. If the DU determines that the DU has not configured a reference C-DU configuration for the UE at block 806, the flow proceeds to block 807 where the DU generates a reference C-DU configuration. At block 808, the DU generates at least one C-DU configuration based on the reference C-DU configuration. At block 810, the DU transmits a DU-to-CU message including the reference C-DU configuration and the at least one C-DU configuration to the CU (e.g., events 374, 390, 490, 590). At block 812, the DU transmits the reference C-DU configuration and the at least one C-DU configuration (i.e., non-reference C-DU configuration) to the UE (e.g., events 509).

Otherwise, if the DU determines that the DU has not configured a reference C-DU configuration for the UE at block 806, the flow proceeds to block 809, where the DU generates at least one C-DU configuration (i.e., non-reference C-DU configuration) based on the reference C-DU configuration. At block 814, the DU transmits a DU-to-CU message including the at least one C-DU configuration to the CU. In such cases, the DU may refrain from including the reference C-DU configuration in the DU-to-CU message. At block 816, the DU transmits the at least one C-DU configuration to the UE (e.g., events 509). In some alternative implementations, the DU transmits the at least one C-DU configuration to the UE 102 via a Master RAN node (e.g., MN or M-DU) (e.g., events 390, 490, 590). In some implementations, the DU refrains from including the reference C-DU configuration in the DU-to-CU message of block 812, which prevents the CU from transmitting the reference C-DU configuration to the UE. Thus, the UE, DU and CU can save power because of refraining from transmitting the reference C-DU configuration.

Examples and implementations described for FIG. 6 can apply to FIGS. 7 and 8.

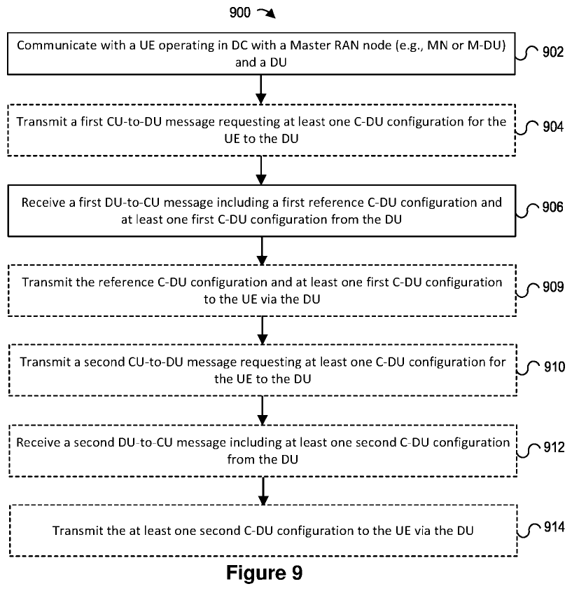

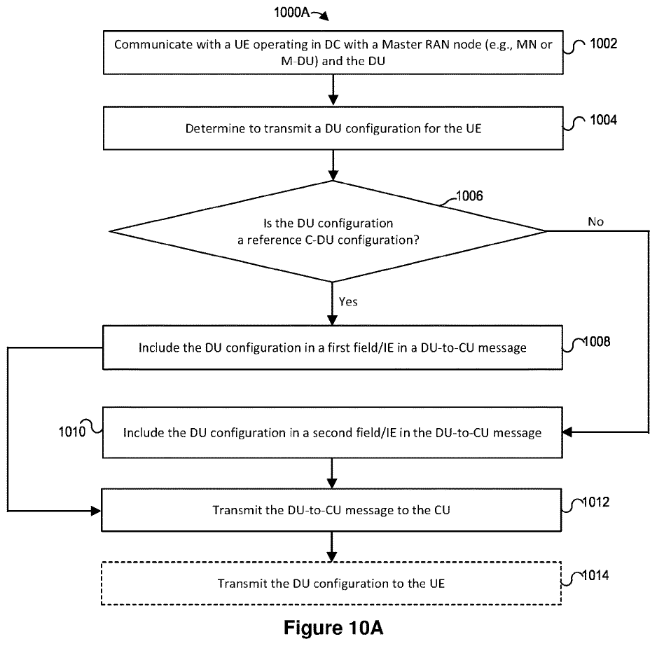

FIG. 9 illustrates a method 900, which can be implemented by a CU (e.g., the CU 172 of the base station 106A or 106B), for configuring selective activation for a UE (e.g., the UE 102).

The method 900 begins at block 902, where the CU communicates with a UE operating in DC with a Master RAN node (e.g., MN or M-DU) and a DU (e.g., events 301, 302, 401, 402, 501, 502). At block 904, the CU transmits a first CU-to-DU message requesting at least one C-DU configuration for the UE to the DU (e.g., events 372, 390,, 490, 590). At block 906, the CU receives from the DU a first DU-to-CU message including a first reference C-DU configuration and at least one first C-DU configuration (i.e., non-reference C-DU configuration) from the DU (e.g., events 374, 390, 490, 590). At block 908, the CU transmits the reference C-DU configuration and at least one first C-DU configuration to the UE via the DU (e.g., events 509). In some alternative implementations, the CU transmits the reference C-DU configuration and at least one first C-DU configuration to the UE via a Master RAN node (e.g., MN or M-DU) (e.g., events 306, 307, 406, 506).

At block 910, the CU transmits a second CU-to-DU message requesting at least one C-DU configuration for the UE to the DU (e.g., events 372, 390, 490, 590). At block 912, the CU receives from the DU a second DU-to-CU message including at least one second C-DU configuration (i.e., non-reference C-DU configuration) from the DU (e.g., events 374, 390, 490, 590). At block 914, the CU transmits the at least one second C-DU configuration to the UE via the DU (e.g., events 509). In some alternative implementations, the CU transmits the at least one second C-DU configuration to the UE via a Master RAN node (e.g., MN or M-DU) (e.g., events 306, 307, 406, 506).

In some implementations, the CU in FIG. 9 is the CU described in FIG. 6, and examples and implementations described for FIG. 6 can apply to FIG. 9.

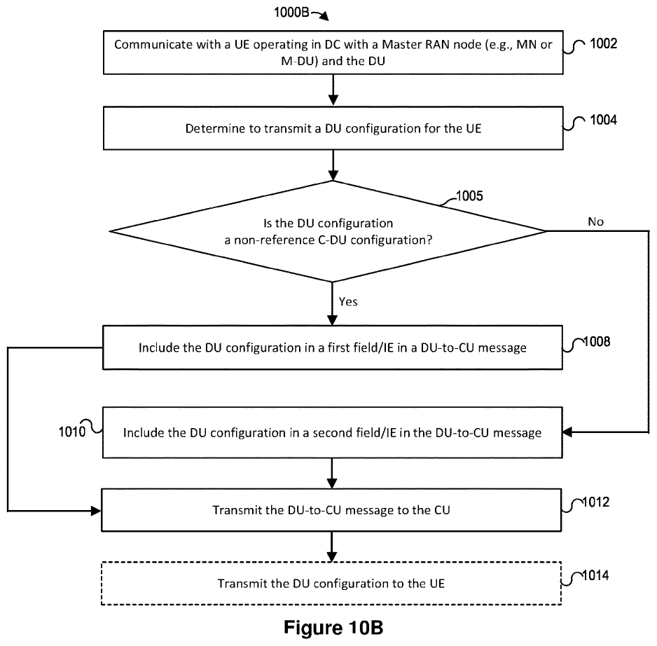

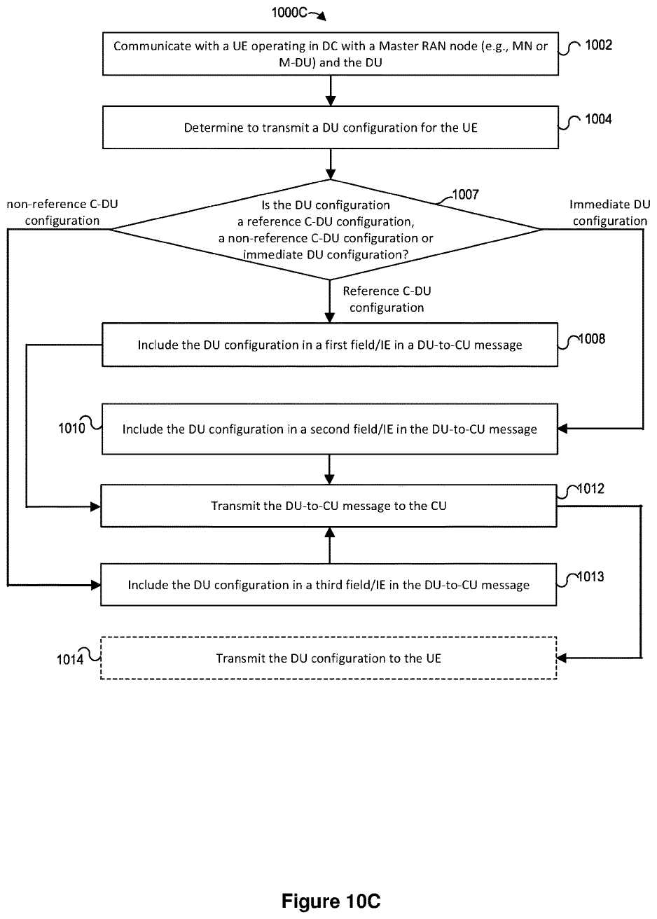

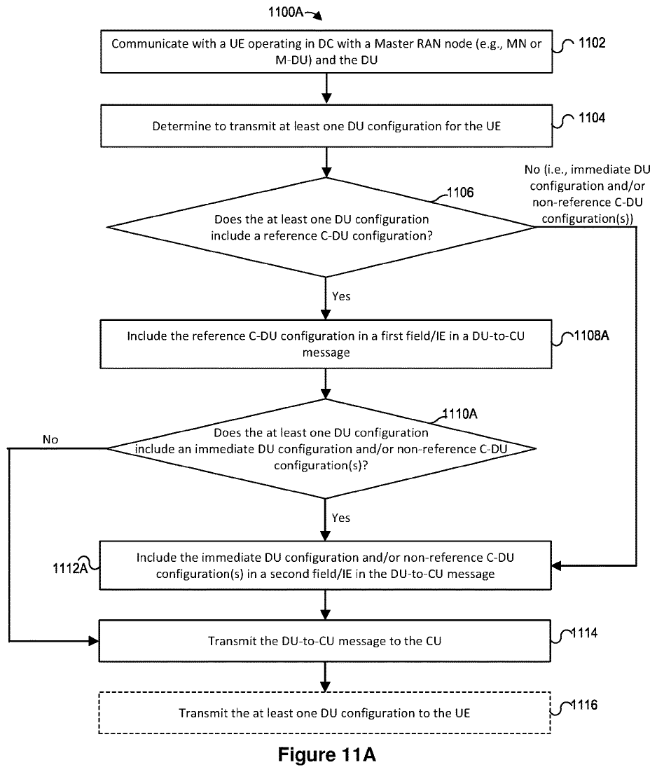

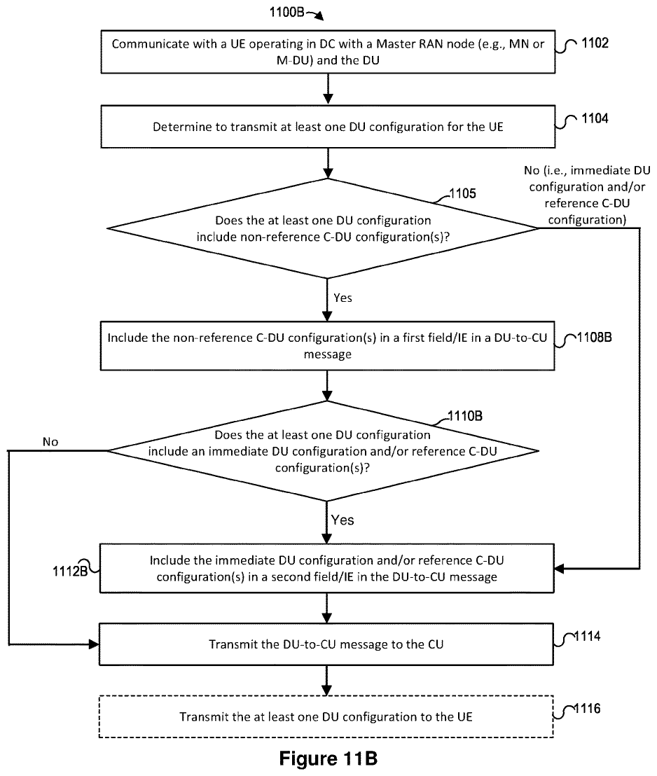

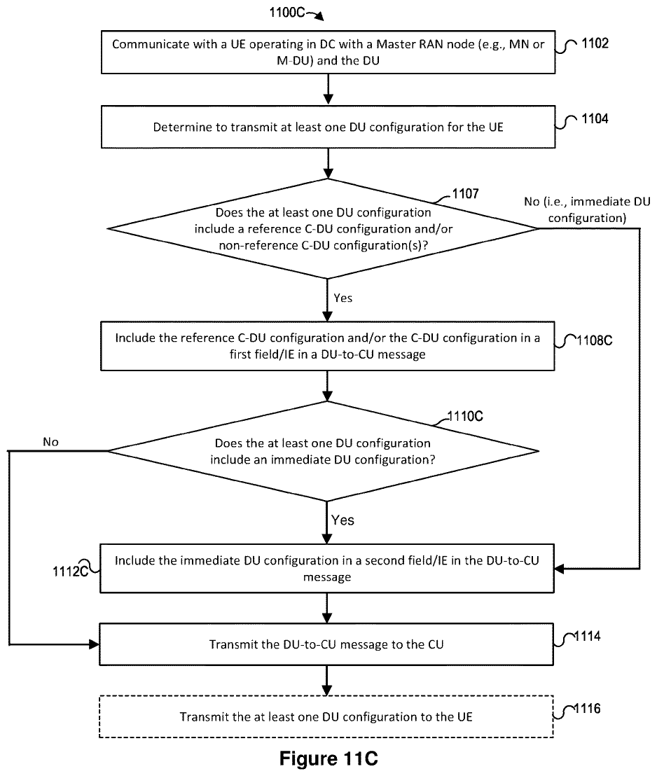

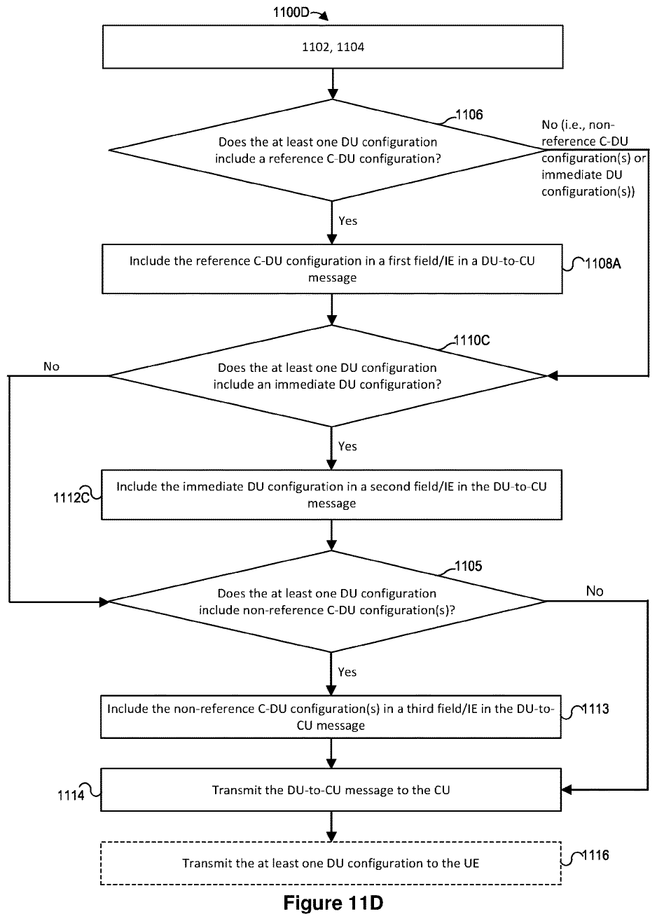

In some implementations, the reference C-DU configuration, non-reference C-DU configuration and immediate DU configuration are configured in the same format (i.e., the DU configuration or CellGroupConfig RRC IE). When the DU transmits a DU configuration to a CU, the CU does not know the received DU configuration is a reference C-DU configuration, non-reference C-DU configuration or an immediate DU configuration. FIGS. 10A-11D illustrates example methods to indicate a DU configuration is a reference C-DU configuration, non-reference C-DU configuration or an immediate C-DU configuration. Thus, the CU can determine a received DU configuration is a reference C-DU configuration, non-reference C-DU configuration or an immediate DU configuration accordingly.

FIG. 10A illustrates an example method 1000A, which can be implemented by a DU (e.g., the (Se-)DU 174B of the base station 106B or 106A), for configuring selective activation for a UE (e.g., the UE 102) and a CU (e.g., the CU 172 of the base station 106B or 106A).

The method 1000A begins at block 1002, where the DU communicates with a UE operating in DC with a Master RAN node (e.g., MN or M-DU) and the DU (e.g., events 301, 401, 402, 501, 502). At block 1004, the DU determines to transmit a DU configuration for the UE. At block 1006, the DU determines whether the DU configuration is a reference C-DU configuration. If the DU determines that the DU configuration is a reference C-DU configuration at block 1006 (i.e., the DU generates the DU configuration as a reference C-DU configuration), the flow proceeds to block 1008 where the DU includes the reference C-DU configuration in a first field/IE in a DU-to-CU message (e.g., events 310, 308, 390, 380, 480, 490, 580, 590). Otherwise, if the DU determines that the DU configuration is not a reference C-DU configuration at block 1006 (i.e., the DU generates the DU configuration not as a reference C-DU configuration), the flow proceeds to block 1010. At block 1010, the DU includes the DU configuration in a second field/IE in the DU-to-CU message. The flow proceeds to block 1012 from block 1008 as well as block 1010. At block 1012, the DU transmits the DU-to-CU message to the CU (e.g., events 374, 390, 490, 590). At block 1014, the DU transmits the DU configuration to the UE (e.g., events 509). Alternatively, the DU transmits the DU configuration to the UE via an Master RAN node (e.g., MN or M-DU) (e.g., events 374, 390, 490, 590).

In some implementations, the first field/IE and second field/IE are F1 application protocol (AP) fields/IEs. In some implementations, the first field/IE is a dedicated (specifically defined for the purposes of this procedure in a relevant specification such as TS 38.473) F1AP field/IE.

In some implementations, in the case that the DU configuration is not a reference C-DU configuration, the DU at block 1006 can determine that the DU configuration is an immediate DU configuration. In this case, the DU includes the immediate DU configuration in the second field/IE at block 1010. In some implementations, the second field/IE can be the DU to CU RRC Information F1AP IE defined in 3GPP specification 38.473. In other implementations, the second field/IE can be the cell GroupConfig F1AP field or CellGroupConfig F1AP IE defined in 3GPP specification 38.473.

In some implementations, in the case that the DU configuration is not a reference C-DU configuration, the DU at block 1006 can determine that the DU configuration is a non-reference C-DU configuration. In this case, the DU includes the non-reference C-DU configuration in the second field/IE at block 1010. In some implementations, the second field/IE can be the DU to CU RRC Information F1AP IE defined in 3GPP specification 38.473. In other implementations, the second field/IE can be the cellGroupConfig F1AP field or CellGroupConfig F1AP IE defined in 3GPP specification 38.473. In some implementations, the DU can include an indication (e.g., a F1AP field/IE) in the DU to CU RRC Information IE to indicate that the DU configuration is a non-reference C-DU configuration. In yet other implementations, the second field/IE is a dedicated (specifically defined for the purposes of this procedure in a relevant specification such as TS 38.473) F1AP field/IE. In some alternative implementations, in the case that the DU configuration is not a reference C-DU configuration, the DU at block 1006 can determine that the DU configuration is a non-reference C-DU configuration. In this case, the DU includes the non-reference C-DU configuration in the first field/IE at block 1008.

In some implementations, the DU configuration is a CellGroupConfig RRC IE defined in 3GPP specification 38.331.

FIG. 10B illustrates an example method 1000B similar to the method 1000A, except that the method 1000B includes blocks 1005 instead of block 1006. At block 1005, the DU determines whether the DU configuration is a non-reference C-DU configuration. If the DU determines that the DU configuration is a non-reference C-DU configuration at block 1005 (i.e., the DU generates the DU configuration as a non-reference C-DU configuration), the flow proceeds to block 1008. Otherwise, if the DU determines that the DU configuration is not a non-reference C-DU configuration at block 1005 (i.e., the DU generates the DU configuration not as a non-reference C-DU configuration), the flow proceeds to block 1010.

In some implementations, in the case that the DU configuration is not a non-reference C-DU configuration, the DU at block 1005 can determine that the DU configuration is an immediate DU configuration. In such cases, examples and implementations described for FIG. 10A can be applied.

In some implementations, in the case that the DU configuration is not a non-reference C-DU configuration, the DU at block 1005 can determine that the DU configuration is a reference C-DU configuration. In this case, the DU includes the reference C-DU configuration in the second field/IE at block 1010. In such cases, examples and implementations for the second field/IE as described for FIG. 6 can be applied. In some implementations, the DU can include an indication (e.g., a F1AP field/IE) in the DU to CU RRC Information IE to indicate that the DU configuration is a reference C-DU configuration.

FIG. 10C illustrates an example method 1000C similar to the method 1000A, except that the method 1000C includes blocks 1007 and 1013 instead of block 1006. At block 1007, the DU determines whether the DU configuration is the DU configuration a reference C-DU configuration, a non-reference C-DU configuration or immediate DU configuration. If the DU determines that the DU configuration is a reference C-DU configuration at block 1007 (i.e., the DU generates the DU configuration as a reference C-DU configuration), the flow proceeds to block 1008. Otherwise, if the DU determines that the DU configuration is an immediate DU configuration (i.e., the DU generates the DU configuration as an immediate DU configuration), the flow proceeds to block 1010. Otherwise, if the DU determines that the DU configuration is a non-reference C-DU configuration (i.e., the DU generates the DU configuration as a non-reference C-DU configuration), the flow proceeds to block 1013. At block 1013, the DU includes the DU configuration in a third field/IE in the DU-to-CU message. The flow proceeds to block 1012 from block 1013.

In some implementations, the first field/IE, second field/IE and third field/IE are F1AP fields/IEs. In some implementations, the first field/IE is a dedicated (specifically defined for the purposes of this procedure in a relevant specification such as TS 38.473) F1AP field/IE defined in 3GPP specification 38.473 v18.0.0 and/or later version.

In some implementations, the second field/IE can be the DU to CU RRC Information F1AP IE defined in 3GPP specification 38.473, and the DU can include an indication (e.g., a F1AP field/IE) in the DU to CU RRC Information IE to indicate that the DU configuration is a non-reference C-DU configuration. In other implementations, the second field/IE can be the cellGroupConfig F1AP field or CellGroupConfig F1AP IE defined in 3GPP specification 38.473. In some implementations, the third field/IE is a dedicated (specifically defined for the purposes of this procedure in a relevant specification such as TS 38.473) F1AP field/IE.

FIG. 11A illustrates an example method 1100A, which can be implemented by a DU (e.g., the (Se-)DU 174B of the base station 106B or 106A), for configuring selective activation for a UE (e.g., the UE 102) and a CU (e.g., the CU 172 of the base station 106B or 106A).

The method 1100A begins at block 1102, where the DU communicates with a UE operating in DC with a Master RAN node (e.g., MN or M-DU) and the DU (e.g., events 301, 401, 402, 501, 502). At block 1104, the DU determines to transmit at least one DU configuration for the UE. At block 1106, the DU determines whether the at least one DU configuration includes a reference C-DU configuration. If the DU determines that the at least one DU configuration includes a reference C-DU configuration at block 1106, the flow proceeds to block 1008A where the DU includes the reference C-DU configuration in a first field/IE in a DU-to-CU message. Otherwise, if the DU determines that the DU configuration does not include a reference C-DU configuration at block 1106, the flow proceeds to block 1110A. At block 1110A, the DU determines whether the at least one DU configuration includes an immediate DU configuration and/or non-reference C-DU configuration(s). If the DU determines that the at least one DU configuration includes an immediate DU configuration and/or non-reference C-DU configuration(s) at block 1110A, the flow proceeds to block 1112A, where the DU includes the immediate DU configuration and/or non-reference C-DU configuration(s) in a second field/IE in the DU-to-CU message. The flow proceeds to block 1114 from block 1112A. Otherwise, if the DU determines that the at least one DU configuration neither includes the immediate DU configuration nor the non-reference C-DU configuration(s) at block 1110A, the flow proceeds to block 1114. At block 1114, the DU transmits the DU-to-CU message to the CU (e.g., events 374, 390, 490, 590). At block 1116, the DU transmits the at least one DU configuration to the UE (e.g., events 509). Alternatively, the DU transmits the at least one DU configuration to the UE via a Master RAN node (e.g., MN or M-DU) (e.g., events 374, 390, 490, 590).

FIG. 11B illustrates an example method 1100B similar to the method 1100A, except that the method 1100B includes blocks 1105, 1108B, 1110B and 1112B instead of blocks 1106, 1108A, 1110A and 1112A. At block 1105, the DU determines whether the at least one DU configuration includes a non-reference C-DU configuration. If the DU determines that the at least one DU configuration includes non-reference C-DU configuration(s) at block 1105, the flow proceeds to block 1108B. At block 1108B, the DU includes the non-reference C-DU configuration(s) in a first field/IE in a DU-to-CU message. The flow then proceeds to block 1110B from block 1108B. At block 1110B, the DU determines whether the at least one DU configuration includes an immediate DU configuration and/or reference C-DU configuration(s). If the DU determines that the at least one DU configuration includes an immediate DU configuration and/or reference C-DU configuration(s) at block 1110B, the flow proceeds to block 1112B. Otherwise, if the DU determines that the at least one DU configuration neither includes an immediate DU configuration nor a reference C-DU configuration at block 1110B, the flow proceeds to block 1114. Otherwise, if the DU determines that the at least one DU configuration does not include a non-reference C-DU configuration at block 1105, the flow proceeds to block 1112B. At block 1112B, the DU includes the immediate DU configuration and/or reference C-DU configuration(s) in a second field/IE in the DU-to-CU message. The flow proceeds to block 1114 from block 1112B.

FIG. 11C illustrates an example method 1100C similar to the method 1100A, except that the method 1100C includes blocks 1107, 1108C, 1110C and 1112C instead of blocks 1106, 1108A, 1110A and 1112A. At block 1107, the DU determines whether the at least one DU configuration includes a reference C-DU configuration and/or non-reference C-DU configuration(s). If the DU determines that the at least one DU configuration include a reference C-DU configuration and/or non-reference C-DU configuration(s) at block 1107, the flow proceeds to block 1108C. At block 1108C, the DU includes the reference C-DU configuration and/or the non-reference C-DU configuration(s) in a first field/IE in a DU-to-CU message. The flow then proceeds to block 1110C from block 1108C. At block 1110C, the DU determines whether the at least one DU configuration includes an immediate DU configuration. If the DU determines that the at least one DU configuration includes an immediate DU configuration at block 1110C, the flow proceeds to block 1112C. Otherwise, if the DU determines that the at least one DU configuration does not include an immediate DU configuration at block 1110C, the flow proceeds to block 1114. Otherwise, if the DU determines that the at least one DU configuration neither includes a reference C-DU configuration nor a non-reference C-DU configuration at block 1107, the flow proceeds to block 1112C. At block 1112C, the DU includes the immediate DU configuration in a second field/IE in the DU-to-CU message. The flow proceeds to block 1114 from block 1112C.

FIG. 11D illustrates an example method 1100D similar to the methods 1100A, 1100B and 1100C, except that the method 1100D includes block 1113. If the DU determines that the at least one DU configuration include a reference C-DU configuration at block 1106, the flow proceeds to block 1108A. The flow then proceeds to block 1110C from block 1108A. Otherwise, if the DU determines that the at least one DU configuration does not include a reference C-DU configuration at block 1106, the flow proceeds to block 1110C. If the DU determines that the at least one DU configuration does not include an immediate DU configuration at block 1110C, the flow proceeds to block 1105. If the DU determines that the DU includes a non-reference C-DU configuration, the flow proceeds to block 1113, where the DU includes the non-reference C-DU configuration(s) in a third field/IE in the DU-to-CU message. The flow then proceeds to block 1114 from block 1113. Otherwise, if the DU determines that the DU does not include a non-reference C-DU configuration, the flow proceeds to block 1114.

Examples and implementations described for FIGS. 10A-10C can apply to FIGS. 11A-11D.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”. In some implementations, “IE” is used and can be replaced by “field”. In some implementations, “configuration” can be replaced by “configurations” or the configuration parameters. In some implementations, the “CPAC”, “CPA” and/or “CPC” are interchangeable. In some implementations, “reference C-SN configuration” can be replaced by “reference C-SN configuration” or “reference configuration”. In some implementations, “triggering condition” and “triggering condition configuration” can be replaced by “execution condition” and “execution condition configuration”, respectively.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The term “or” as used herein is to be interpreted as an inclusive or meaning any one or any combination, unless expressly indicated otherwise, mutually exclusive, or indicated otherwise by context. Therefore, herein, the expression “A or B” means “A, B, or both A and B.”

What is claimed is:

1. A configuration method implemented in a central unit (CU) of a distributed base station equipped with a first distributed unit (DU) and a second distributed unit (DU), the method comprising:
communicating with a user equipment (UE) in dual connectivity (DC), with the first DU operating as a master node (M-DU), and the second DU operating as a secondary node (Se-DU);
transmitting, to the Se-DU, a CU-to-DU message including a request for reference conditional DU (C-DU) configuration;
receiving, from the Se-DU, a DU-to-CU message including the reference C-DU configuration; and
generating a conditional SN (C-SN) configuration for the UE based on the reference C-DU configuration.

2. The method of claim 1, wherein:
the C-SN configuration includes a plurality of candidate cells for a subsequent primary secondary cell (PSCell) addition or change (CPAC) procedure, for performing a plurality of CPAC procedures at the UE based on the C-SN configuration.

3. The method of claim 2, wherein the transmitting of the request includes:
transmitting an information element (IE) defined specifically for the subsequent CPAC procedure.

4. The method of any of claims 1-3, wherein:
the reference C-DU configuration includes a CellGroupConfig IE.

5. The method of any of the preceding claims, wherein:
the C-SN configuration includes an indication of a full configuration.

6. The method of any of the preceding claims, further comprising:
transmitting the C-SN configuration to the UE via the M-DU.

7. The method of any of claims 1-5, further comprising:
transmitting the C-SN configuration to the UE via the Se-DU.

8. The method of any of the preceding claims, wherein:
the DU-to-CU message includes a non-reference C-DU configuration.

9. The method of claim 8, further comprising:
transmitting the non-reference C-DU configuration to the UE.

10. The method of any of the preceding claims, wherein:
the CU-to-DU message is a UE context modification request message; and
the DU-to-CU message is a UE context modification response message.

11. The method of any of the preceding claims, wherein the reference C-DU configuration is equal to a serving DU configuration.

12. A method implemented in a distributed unit (DU) of a distributed base station, the method comprising:
providing, with a master node (MN), dual connectivity to a user equipment (UE);
receiving an indication to perform a preparation procedure for subsequent conditional primary-secondary cell (PSCell) addition or change (CPAC) at the UE;
transmitting, to a central unit (CU) of the distributed base station and responsive to the receiving the indication, a reference conditional DU (C-DU) configuration; and
receiving, from the CU, a conditional SN (C-SN) configuration for the UE.

13. The method of claim 12, wherein:
the DU is a first DU;
the MN is implemented in a second DU of the distributed base station.

14. The method of claim 12 or 13, further comprising:
transmitting, from the DU to the CU, an indication of whether the reference C-DU configuration is a complete configuration.

15. A radio access network (RAN) node comprising processing hardware and configured to perform a method according to any one of the preceding claims.
